(19) United States
(12) Patent Application Publication
(10) Pub. No.: US 2026/0032270 A1
(43) Pub. Date: Jan. 29, 2026

(54) MEDIA DATA PROCESSING

(71) Applicant: TENCENT TECHNOLOGY (SHENZHEN) COMPANY LIMITED, Shenzhen (CN)

(72) Inventors: Ying HU, Shenzhen (CN); Xiaozhong XU, Shenzhen (CN)

(73) Assignee: TENCENT TECHNOLOGY (SHENZHEN) COMPANY LIMITED, Shenzhen, GD (CN)

(21) Appl. No.: 19/349,540

(22) Filed: Oct. 3, 2025

Related U.S. Application Data
(63) Continuation of application No. PCT/CN2024/108802, filed on Jul. 31, 2024.

(30) Foreign Application Priority Data
Aug. 18, 2023 (CN) 202311055036.5

(51) Int. Cl. H04N 19/20; H04N 19/136; H04N 19/156; H04N 19/172; H04N 19/174; H04N 19/46

(52) U.S. Cl. CPC H04N 19/20; H04N 19/136; H04N 19/156; H04N 19/172; H04N 19/46; H04N 19/174

(57) ABSTRACT

Some aspects of the disclosure provide a method for processing media data. In some examples, object indication information associated with N media frames is received. The object indication information is indicative of respective object property features of media objects in the N media frames and respective distribution features of the media objects in the N media frames, and N is a positive integer. According to the object indication information associated with the N media frames, a to-be-decoded media file segment is acquired from an encapsulated media file, the N media frames are encapsulated in the encapsulated media file. The to-be-decoded media file segment is decoded to obtain media data from the to-be-decoded media file segment. Apparatus and non-transitory computer-readable storage medium counterpart embodiments are also contemplated.

### RELATED APPLICATIONS

The present application is a continuation of International Application No. PCT/CN2024/108802, filed on Jul. 31, 2024, which claims priority to Chinese Patent Application No. 202311055036.5, filed on Aug. 18, 2023. The entire disclosures of the prior applications are hereby incorporated by reference.

### FIELD OF THE TECHNOLOGY

This disclosure relates to the technical field of cloud and Internet of vehicles, and in particular, to a method and apparatus for processing media data, a device, and a storage medium.

### BACKGROUND OF THE DISCLOSURE

With the development of digital media technologies and computer technologies, media data (such as video data and point cloud data) are applied to various fields such as mobile communication, network games, and network televisions, which brings great convenience to entertainment and life of people. Under a limited bandwidth, an encoding device needs to encode and encapsulate acquired media data to obtain an encapsulated media file related to the media data, and transmits the encapsulated media file related to the media data to a decoding terminal. Generally, the decoding device only requires some media data in the encapsulated media file. But currently, the media data required by the decoding device can be obtained only after an entire encapsulated media file is decoded. In consequence, efficiency of acquiring the media data is low, and unnecessary resource overhead is caused.

### SUMMARY

A method and apparatus for processing media data, a device, and a storage medium are provided in embodiments of this disclosure, so as to improve efficiency of acquiring the media data and reduce resource overhead of a decoding device.

Some aspects of the disclosure provide a method for processing media data. In some examples, object indication information associated with N media frames is received. The object indication information is indicative of respective object property features of media objects in the N media frames and respective distribution features of the media objects in the N media frames, and N is a positive integer. According to the object indication information associated with the N media frames, a to-be-decoded media file segment is acquired from an encapsulated media file, the N media frames are encapsulated in the encapsulated media file. The to-be-decoded media file segment is decoded to obtain media data from the to-be-decoded media file segment.

Some aspects of the disclosure provide an apparatus that includes processing circuitry configured to perform the method for processing media data.

Some aspects of the disclosure also provide a non-transitory computer-readable storage medium storing instructions which when executed by at least one processor cause the at least one processor to perform the method for processing media data.

Some aspects of the disclosure provide another method for processing media data. For example, an encapsulated media file that includes N media frames is acquired, N is a positive integer. When the N media frames comprise media objects, object indication information associated with the N media frames is generated, the object indication information indicates respective object property features of the media objects in the N media frames and respective distribution features of the media objects in the N media frames. The encapsulated media file and the object indication information are transmitted to a decoding device.

Some aspects of the disclosure provide an apparatus that includes processing circuitry configured to perform the other method for processing media data.

Some aspects of the disclosure also provide a non-transitory computer-readable storage medium storing instructions which when executed by at least one processor cause the at least one processor to perform the other method for processing media data.

In an aspect, a method for processing media data is provided in the embodiments of this disclosure. The method includes: receiving object indication information, the object indication information being configured for reflecting object property features of media objects in N media frames and distribution features of the media objects in the N media frames, and N being a positive integer; acquiring a to-be-decoded media file segment from an encapsulated media file corresponding to the N media frames according to the object indication information; and decoding the to-be-decoded media file segment, so as to obtain media data corresponding to the to-be-decoded media file segment.

In an aspect, a method for processing media data is provided in the embodiments of this disclosure. The method includes: acquiring an encapsulated media file related to N media frames, N being a positive integer; generating, if the N media frames include media objects, object indication information related to the N media frames, the object indication information being configured for indicating object property features corresponding to the media objects in the N media frames and distribution features of the media objects in the N media frames; and transmitting the encapsulated media file and the object indication information to a decoding device.

In an aspect, an apparatus for processing media data is provided in the embodiments of this disclosure. The apparatus includes: a reception module configured to receive object indication information, the object indication information being configured for reflecting object property features of media objects in N media frames and distribution features of the media objects in the N media frames, and N being a positive integer; a first acquisition module configured to acquire a to-be-decoded media file segment from an encapsulated media file corresponding to the N media frames according to the object indication information; and a decoding module configured to decode the to-be-decoded media file segment, so as to obtain media data corresponding to the to-be-decoded media file segment.

In an aspect, an apparatus for processing media data is provided in the embodiments of this disclosure. The apparatus includes: a second acquisition module configured to acquire an encapsulated media file related to N media frames, N being a positive integer; a generation module configured to generate, if the N media frames include media objects, object indication information related to the N media frames, the object indication information being configured for indicating object property features corresponding to the media objects in the N media frames and distribution features of the media objects in the N media frames; and a transmission module configured to transmit the encapsulated media file and the object indication information to a decoding device.

In an aspect, a computer device is provided in the embodiments of this disclosure. The computer device includes a memory and a processor (an example of processing circuitry), the memory having a computer program stored therein, and the processor, when executing the computer program, implementing operations of the method.

In an aspect, a computer-readable storage medium (e.g., non-transitory computer-readable storage medium) is provided in the embodiments of this disclosure. The computer-readable storage medium has a computer program stored therein, the computer program, when executed by a processor, implementing operations of the method.

In an aspect, a computer program product is provided in the embodiments of this disclosure. The computer program product includes a computer program, the computer program, when executed by a processor, implementing operations of the method.

In this disclosure, the decoding device may receive the object indication information. The object indication information is configured for reflecting the object property features of the media objects in the N media frames and the distribution features of the media objects in the N media frames. For example, the object indication information is configured for reflecting types of the media objects included in the N media frames, the media frames including the media objects, positions for including the media objects of the media frames, etc. The decoding device can rapidly acquire the required media frame (i.e. media data) based on the object indication information. Thus, the to-be-decoded media file segment can be rapidly acquired from the encapsulated media file corresponding to the N media frames according to the object indication information. The to-be-decoded media file segment can be a media file segment corresponding to the media data required by the decoding device. Thus, efficiency of acquiring the to-be-decoded media file segment can be improved. Further, the media data (such as the media data required by the decoding device) corresponding to the to-be-decoded media file segment can be obtained by decoding only the to-be-decoded media file segment, instead of decoding an entire media file. Thus, a number of to-be-decoded data can be decreased, efficiency of acquiring the media data can be improved, and resource (such as computing resource) overhead of the decoding device can be reduced.

### BRIEF DESCRIPTION OF THE DRAWINGS

FIG. 1 is an architectural diagram of processing media data according to this disclosure;

FIG. 2 is a schematic flowchart of a method for processing media data according to this disclosure;

FIG. 3 is a schematic diagram of single-track encapsulation according to an embodiment of this disclosure;

FIG. 4 is a schematic diagram of component based multi-track encapsulation according to an embodiment of this disclosure;

FIG. 5 is a schematic diagram of slice based multi-track encapsulation according to an embodiment of this disclosure;

FIG. 6 is a schematic diagram of slice based multi-track encapsulation according to an embodiment of this disclosure;

FIG. 7 is a schematic diagram of a target media file according to an embodiment of this disclosure;

FIG. 8 is a schematic diagram of a target media file according to an embodiment of this disclosure;

FIG. 9 is a schematic flowchart of a method for processing media data according to an embodiment of this disclosure;

FIG. 10 is a schematic structural diagram of an apparatus for processing media data according to an embodiment of this disclosure;

FIG. 11 is a schematic structural diagram of an apparatus for processing media data according to an embodiment of this disclosure;

FIG. 12 is a schematic structural diagram of a computer device according to an embodiment of this disclosure; and

FIG. 13 is a schematic structural diagram of a computer device according to an embodiment of this disclosure;

### DESCRIPTION OF EMBODIMENTS

The following describes technical solutions in embodiments of this disclosure with reference to the accompanying drawings. The described embodiments are some of the embodiments of this disclosure rather than all of the embodiments. Other embodiments are within the scope of this disclosure.

This disclosure relates to the technical field of cloud. This disclosure relates to cloud computing in the technical field of cloud. Cloud computing, a type of computing mode, is to distribute computing tasks on a resource pool formed by a large number of computers. Thus, various application systems can acquire computing power, storage space, and information service as demanded. A network that provides a resource is referred to as a “cloud”. For a user, resources in the “cloud” are infinitely expandable, acquirable and expandable at any time and usable on demand. In this disclosure, object indication information related to a media frame can be generated through cloud computing.

The media frame in this disclosure may include a video frame in video data, a point cloud frame in point cloud data, etc. When an application scenario of this disclosure is a scenario for processing the video data (to be specific, when the media frame in this disclosure is the video frame in the video data), the embodiments of this disclosure relate to a technology of processing video data. A complete procedure of processing the video data may include: video collection, video encoding, video file encapsulation, video transmission, video file decapsulation, video decoding, and final video demonstration. When an application scenario of this disclosure is a scenario for processing the point cloud data (to be specific, when the media frame in this disclosure is the point cloud frame in the point cloud data), the embodiments of this disclosure relate to a technology of processing the point cloud data. A complete procedure of processing the point cloud data may include: point cloud data acquisition, encoding and file encapsulation of the point cloud data, point cloud data transmission, file decapsulation and decoding of the point cloud data, and point cloud data rendering.

The media in this disclosure may be immersive media. The immersive media indicate media contents that bring immersive experience to consumers. The immersive media may be classified into 3 degree of freedom (DoF) media, 3DoF+ media, and 6DoF media according to degrees of freedom when the consumers consume the media contents. The point cloud data are typical 6DoF media. The point cloud data indicate a set of discrete data points that are irregularly distributed and express spatial structures and surface properties of 3-dimension articles or scenarios in space. Each data point in the point cloud data has at least geometry position information (i.e. 3-dimension position information), and also has a color property, a material property, etc. according to different application scenarios. Each point in the point cloud generally has a same number of additional properties.

The point cloud data can flexibly and conveniently express the spatial structures and the surface properties of the 3-dimension articles or scenarios, and thus are applied to virtual reality (VR) games, computer aided design (CAD), geography information systems (GISs), autonomous navigation systems (ANSs), digital cultural heritage, free-viewpoint broadcasting, 3-dimension immersive telepresence, 3-dimension reconstruction of biological tissues and organs, etc. in a wide range.

Currently, with the ongoing development of science and technologies, a large number of high-precision point cloud data can be obtained with low costs in a short period of time. For example, the point cloud data can be obtained after a collection device (a camera group or a camera device with a plurality of lenses and a plurality of sensors) collects a visual scenario in the real world. Point clouds (millions per second) of a static real-world 3-dimension (3D) article or scenario can be obtained through 3D scanning. Through 3D photographing, a point cloud (tens of millions per second) of a dynamic real-world 3-dimension article or scenario can be obtained. In addition, in the field of medicine, the point cloud data of the biological tissue and organ can be obtained through magnetic resonance imaging (MRI), computed tomography (CT), and electromagnetic location information. For another example, the point cloud data or can be directly generated by the computer according to a virtual 3-dimension article and scenario. With the continuous accumulation of a large number of point cloud data, efficient storage, transmission, release, sharing, and standardization of the point cloud data are vital to point cloud application.

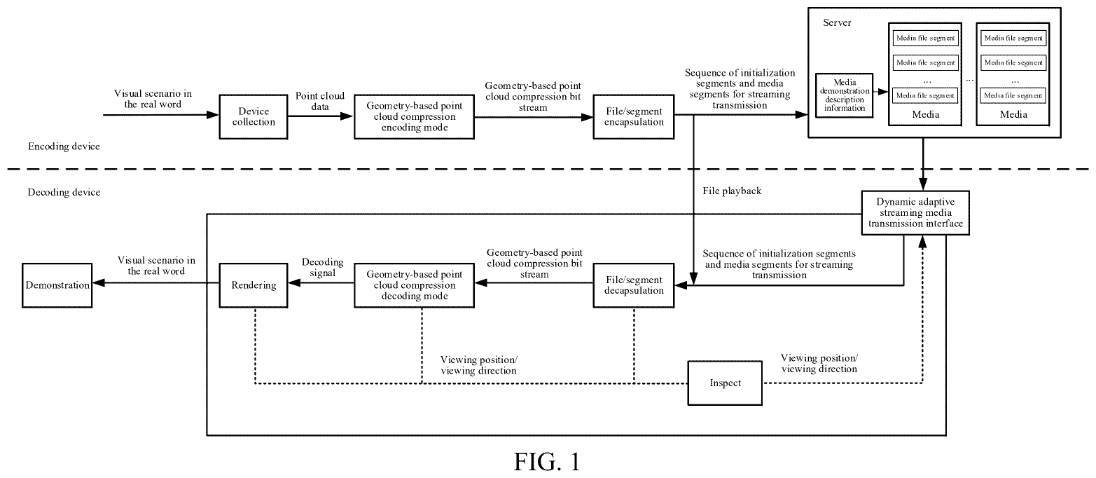

FIG. 1 is an architectural diagram of processing media data according to an exemplary embodiment of this disclosure. As shown in FIG. 1, a procedure of processing data by an encoding device mainly includes: (1) a procedure of acquisition of point cloud data; and (2) a procedure of encoding and file encapsulation of the point cloud data. A procedure of processing data by a decoding device mainly includes: (3) a procedure of file decapsulation and decoding of the point cloud data; and (4) a procedure of rendering of the point cloud data. A transmission procedure of the point cloud data is involved between the encoding device and the decoding device. The transmission procedure may be performed based on various transmission protocols. The transmission protocol herein may include, but is not limited to: the dynamic adaptive streaming over hyper text transfer protocol (HTTP) (DASH), the HTTP live streaming (LS) protocol, the smart media transport protocol (SMTP), the transmission control protocol (TCP), etc.

A procedure of processing media data is described in detail below.

(1) Acquisition of point cloud data is performed.

The point cloud data are acquired as follows: The point cloud data are acquired from a real-world audio-visual scenario by a capture device and generated through the computer. In an implementation, the capture device may be a hardware component arranged in the encoding device. For example, the capture device is a microphone, a camera, or a sensor of a terminal. In another implementation, the capture device or may be a hardware apparatus connected to the encoding device, for example, a camera connected to a server, and is configured to provide service of acquiring a media content of the point cloud data for the encoding device. The capture device may include, but is not limited to, an audio device, a photographing device, and a sensing device. The audio device may include an audio sensor, a microphone, etc. The photographing device may include a common camera, a stereo camera, a light-field camera, etc. The sensing device may include a laser device, a radar device, etc. Certainly, the point cloud or may be acquired in the following ways: 3D laser scanning, 3D photogrammetry, etc. The computer may generate the point cloud of the virtual 3-dimension article and scenario. 3D scanning may obtain the point cloud (millions per second) of the static real-world 3-dimension article or scenario. 3D photographing may obtain the point cloud (ten millions per second) of the dynamic real-world 3-dimension article or scenario. In addition, in the field of medicine, the point cloud of the biological tissue and organ may be obtained through the MRI, CT, and electromagnetic location information. These technologies reduce costs and shorten the period of time for acquiring the point cloud data and improve data precision. With the revolution of the point cloud data acquisition mode, it is possible to obtain a large number of point cloud data. A plurality of capture devices may be used, and these capture devices are deployed at some particular positions in real space to simultaneously capture audio contents and video contents of the space in different angles. The captured audio contents and video contents are synchronized in time and space. Owing to different acquisition modes, compression and encoding modes corresponding to different point cloud data may also be different.

The point cloud data include a plurality of point cloud samples, one point cloud sample may also be referred to as a point cloud frame and include at least one of geometry data and property data, and the property data include a color property, reflectivity, etc. The geometry data are configured for reflecting position information of the point cloud sample in a collected object. The color property is configured for reflecting color information of the collected object. The reflectivity is configured for reflecting reflectivity of the collected object.

(2) The procedure of encoding and file encapsulation of the point cloud data is performed.

Encoding of the point cloud data includes geometry data encoding and property data encoding. The geometry data encoding is to encode geometry data of the point cloud sample in the point cloud data, so as to obtain geometry encoded data of the point cloud sample. The geometry data encoding may include the following two modes: (a) octree based geometry encoding: The octree, a type of tree data structure, is to evenly divide a point cloud bounding box (i.e. a smallest cube including all point clouds) in 3D space, where each node has eight sub-nodes. Whether each sub-node of the octree is occupied is indicated by “1” or “0”, so that an occupancy code is obtained as the geometry encoded information of the point cloud sample. (b) trisoup based geometry encoding: The point cloud (i.e. the point cloud sample) is divided into blocks with a particular size, intersections of a surface of the point cloud at edges of the blocks are located to construct a triangle, and the geometry encoded data of the point cloud sample is obtained by encoding intersection positions. Property data encoding is to encode the color property, reflectivity, etc. of the point cloud sample, so as to obtain property encoded data of the point cloud sample.

A procedure of encapsulating the point cloud data includes the following operations: The encoding device encapsulates the encoded data of the point cloud sample and a parameter header included in the point cloud sample to obtain code stream data of the point cloud data, and encapsulates the code stream data of the point cloud data in a media track. The encoded data of the point cloud sample herein includes at least one of the property encoded data and the geometry encoded data of the point cloud sample. The parameter header included in the point cloud sample includes at least one of a geometry parameter header, a property parameter header, and a sequence parameter header. The geometry parameter header includes a parameter required for decoding the geometry encoded data of the point cloud sample. The property parameter header includes a parameter required for decoding the property encoded data of the point cloud sample. The sequence parameter header includes a parameter (i.e. a shared parameter) required for decoding a point cloud sample in a sequence in which the point cloud sample is located. Since the parameters required for decoding some point cloud samples are the same, only some point cloud samples in the point cloud data include parameter headers.

The media track herein is a media data set generated in a procedure of encapsulating the code stream data of the point cloud data. The media track may include a plurality of time-sequential media track samples, and one media track sample may be configured to encapsulate code stream data of one point cloud frame. The code stream data of the point cloud data may be encapsulated in one or more media tracks. For example, an encapsulated media file may include a video media track, an audio media track, and a caption media track. The sample is an encapsulation unit in a procedure of encapsulating the media file. One track includes a plurality of samples. Each sample corresponds to particular timestamp information. For example, one video media track may include a plurality of samples, and one sample is generally a video frame. One sample in the point cloud media track may be one point cloud frame, and each sample has its own sample number. For example, a first sample in the track has a sample number of 1. Each track has a sample entry. The sample entry is configured to indicate metadata information related to all samples in the track. For example, a sample entry of the video track generally includes metadata information related to initialization of a decoder.

In some examples, when the media data are static media data, code stream data corresponding to the static media data may be encapsulated as an item. The item is a media data set generated in a procedure of encapsulating a static media file. For example, a static picture is encapsulated as one item. The point cloud frame may be divided to obtain point cloud slices (or referred to as point cloud strips). The point cloud slice/point cloud strip denotes a set of a series of syntax elements (such as geometry slices and property slices) of some or all of encoded point cloud frame data. One point cloud slice corresponds to points in a spatial region of the point cloud frame. The encoding device may perform encapsulation processing according to a particular media container file format (such as ISOBMFF), and combine one or more encoded bit streams into a file sequence (Fs) of initialization segments and media segments (such as media file segments) for streaming transmission or a file (F) for file playback. Moreover, the file encapsulation is further to include metadata into the file (F) or the file sequence (Fs), and transmit the file sequence (Fs) to the decoding device (for example, a player) through a transmission mechanism.

(3) The procedure of file decapsulation and decoding of the point cloud data is performed.

The decoding device may obtain media file resources (such as the media track and the media item) of the point cloud data and corresponding media demonstration description information through the encoding device. The media file resources of the point cloud data and the media demonstration description information are transmitted from the encoding device to the decoding device through a transmission mechanism (such as DASH and SMT). A procedure of decapsulating the file by the decoding device is reversed to a procedure of encapsulating the file by the encoding device. The decoding device decapsulates the media file resources according to the file format requirement of the point cloud media, so as to obtain an encoded bit stream. The encoded bit stream may also be referred to as code stream data that may be a geometry-based point cloud compression (GPCC) bit stream or a video based point cloud compression (VPCC) bit stream. The procedure of decoding by the decoding device is also reversed to the procedure of encoding by the encoding device. The decoding device decodes the encoded bit stream to restore the point cloud sample of the point cloud data. After receiving the file sequence (Fs) of the initialization segments and the media segments for streaming transmission or the file (F) for file playback, the decoding device may decapsulate the file sequence (Fs) or the file (F), extract the code stream data of the point cloud data, and decode the code stream data of the point cloud data based on corresponding metadata, so as to obtain the corresponding point cloud data.

(4) The procedure of rendering of the point cloud data is performed.

The decoding device renders the point cloud data obtained by decoding the GPCC bit stream according to metadata related to rendering and a window in the media demonstration description information, and demonstrates a visual scenario corresponding to the point cloud data after rendering is completed.

In an embodiment, the encoding device is configured to: sample a visual scenario in the real world through a collection device, so as to obtain point cloud data corresponding to the visual scenario in the real world; encode the point cloud data obtained through geometry-based point cloud compression (GPCC) or video based point cloud compression (VPCC), so as to obtain the GPCC bit stream (including an encoded geometry bit stream and an encoded property bit stream) or a VPCC bit stream; and encapsulate the GPCC bit stream or the VPCC bit stream, so as to obtain a media file (i.e. a point cloud media) corresponding to the point cloud data. In some examples, according to a particular media container file format, the encoding device combines one or more encoded bit streams into a file for file playback or a file sequence of initialization segments and media segments for streaming transmission. The media container file format indicates an international organization for standardization (ISO) base media file format specified in the (ISO)/international electrotechnical commission (IEC) 14496-12. In an implementation, the encoding device further encapsulates the metadata in the file or the file sequence of the initialization segments/media segments, and transmits the file sequence of the initialization segments/media segments to the decoding device through a transmission mechanism (such as a dynamic adaptive streaming media transmission interface).

The decoding device is configured to: receive a point cloud media file transmitted by the encoding device, the point cloud media file including the file for file playback or the file sequence of the initialization segments and the media segments for streaming transmission; decapsulate the point cloud media file, so as to obtain the encoded GPCC bit stream or the encoded VPCC bit stream and metadata related to demonstration of the point cloud media file; parse the encoded GPCC bit stream (i.e. to decode the encoded GPCC bit stream, so as to obtain the point cloud data); and finally render the decoded point cloud data based on a viewing (window) direction of a current user, and display rendered point cloud data on a screen of a head-mounted display, etc. carried by the decoding device. The viewing (window) direction of the current user is determined through a head detection function and possibly a visual detection function. In addition to a renderer that is configured to render the point cloud data in the viewing (window) direction of the current user, an audio decoder may also be configured to perform decoding optimization on audio in the viewing (window) direction of the current user. In a procedure of processing media, the point cloud data may be rendered and displayed on the screen of the head-mounted display, etc. according to a current viewing position or viewing direction, or a window determined by various types of sensors (such as a head sensor, a position sensor, and an eye movement sensor). Point cloud data that are partially accessed and decoded according to the current viewing position or viewing direction may be configured for optimizing the procedure of processing media. In the window based transmission procedure, the current viewing position and viewing direction are also transmitted to a policy module and configured for determining the track for reception.

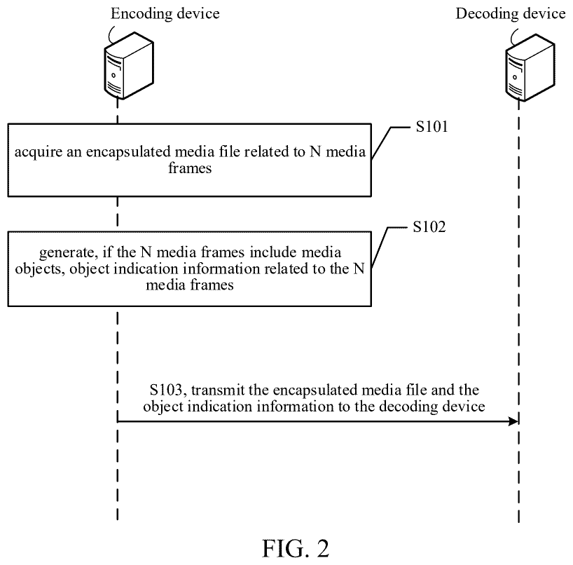

Further, with reference to FIG. 2, a schematic flowchart of a method for processing media data according to an embodiment of this disclosure is shown. As shown in FIG. 2, the method may be performed by the encoding device. The computer device may be the encoding device. The method may include, but is not limited to, the following operations:

S101, acquire an encapsulated media file related to N media frames.

In some examples, the computer device may acquire the encapsulated media file related to the N media frames, N being a positive integer. The embodiment of this disclosure may be applied to a point cloud data scenario. To be specific, the N media frames may be point cloud frames in the point cloud data. Certainly, the embodiment or may be applied to other types of media scenarios, such as a video data scenario. To be specific, the N media frames may be video frames in video data. In some examples, after acquiring the N media frames, the computer device may encode the N media frames, so as to obtain code stream data (such as a media bit stream) of the N media frames. Further, the computer device may encapsulate the code stream data of the N media frames, so as to obtain an encapsulated media file related to the code stream data of the N media frames.

In some examples, encapsulating the code stream data of the N media frames includes, but is not limited to, the following three modes: mode 1: single-track encapsulation; mode 2: component based multi-track encapsulation; and mode 3: slice based multi-track encapsulation.

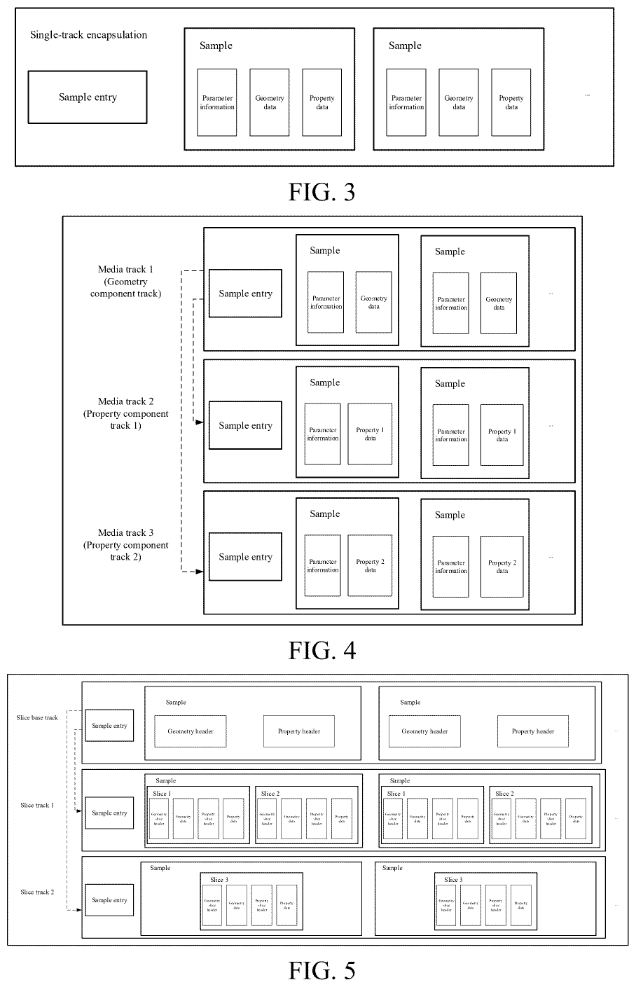

In some examples, as shown in FIG. 3, a schematic diagram of single-track encapsulation according to an embodiment of this disclosure is shown. As shown in FIG. 3, the computer device may encapsulate the code stream data of the N media frames in one media track. The media track includes a sample entry and one or more samples. The sample entry of the media track is configured to encapsulate metadata information related to all samples in a current media track. The metadata information is configured for instructing the decoding device to decapsulate the samples in the current media track based on the metadata information in the sample entry. One sample in the media track is configured to encapsulate code stream data of one media frame. The sample may be configured to encapsulate parameter information of an encapsulated media frame. The parameter information is a parameter set required when the code stream data corresponding to the media frame are decoded. The sample or may be configured to encapsulate geometry data of the media frame. The geometry data include geometry information (such as position information) corresponding to the media frame. The sample or may be configured to encapsulate property data of the media frame. The property data include property information (such as a color property, reflectivity, etc.) corresponding to the media frame.

In some examples, as shown in FIG. 4, a schematic diagram of component based multi-track encapsulation according to an embodiment of this disclosure is shown. As shown in FIG. 4, the computer device may encapsulate code stream data of the N media frames in a plurality of media tracks. In some examples, geometry data acquired through a geometry component may be encapsulated in one media track, for example, a media track 1 (a geometry component track). The media track 1 includes one sample entry and one or more samples. The sample entry of the media track 1 is configured to encapsulate metadata information related to all samples in a current media track. The metadata information is configured for instructing the decoding device to decapsulate the samples in the current media track based on the metadata information in the sample entry. One sample in the media track 1 is configured to encapsulate parameter information (such as geometry parameter information) and geometry data of one media frame. In some examples, the computer device may encapsulate property data acquired through a property component 1 in a media track 2 (i.e. a property component track 1). Similarly, the media track 2 includes one sample entry and one or more samples. The sample entry of the media track 2 is configured to encapsulate metadata information related to all samples in a current media track. One sample in the media track 2 is configured to encapsulate parameter information (such as property 1 parameter information) and property 1 data of one media frame. In some examples, the computer device may encapsulate the property data acquired through a property component 2 in a media track 3 (i.e. a property component track 2). Similarly, the media track 3 includes one sample entry and one or more samples. The sample entry of the media track 3 is configured to encapsulate metadata information related to all samples in a current media track. One sample in the media track 3 is configured to encapsulate parameter information (such as property 2 parameter information) and property 2 data of one media frame. Moreover, an association relation may be established among the media track 1, the media track 2, and the media track 3.

In some examples, as shown in FIG. 5, a schematic diagram of slice based multi-track encapsulation according to an embodiment of this disclosure is shown. As shown in FIG. 5, the computer device may divide each of the N media frames, so as to obtain a plurality of slices. For example, the computer device divides each media frame into three slices, i.e. a slice 1, a slice 2, and a slice 3. The computer device may encapsulate code stream data corresponding to the N media frames in a plurality of media tracks based on the slices. In some examples, the computer device may encapsulate slice information of the media frame in a slice base track. The slice base track also includes one sample entry and a plurality of samples. Similarly, the sample entry of the slice base track is configured to store metadata information of samples in the slice base track. One sample in the slice base track is configured to store slice information of one media frame. To be specific, a geometry header (such as a parameter set required for decoding geometry data) and a property header (such as a parameter set required for decoding property data) corresponding to the media frame are encapsulated in each sample.

As shown in FIG. 5, the computer device may encapsulate the geometry data and the property data together, to be specific, encapsulate code stream data corresponding to a slice 1 and a slice 2 in each media frame respectively in one media track, i.e. a slice track 1; and encapsulate code stream data corresponding to a slice 3 in another media track, i.e. a slice track 2. The slice track 1 also includes one sample entry and a plurality of samples. The sample entry is configured to encapsulate metadata information of all samples in the slice track 1. Each sample in the slice track 1 is configured to encapsulate the code stream data corresponding to the slice 1 and the slice 2 in one media frame respectively. In some examples, one sample may be configured to store a geometry slice header (i.e. a geometry parameter of the slice), a geometry code stream, a property segment (i.e. a property parameter of the slice), and a property code stream of the slice 1 in one media frame, and a geometry slice header (i.e. a geometry parameter of the slice), geometry data, a property segment (i.e. a property parameter of the slice), and property data of the slice 2 in the one media frame. The slice track 2 also includes one sample entry and a plurality of samples. The sample entry is configured to encapsulate metadata information of all samples in the slice track 2. Each sample in the slice track 2 is configured to encapsulate the code stream data corresponding to the slice 3 in one media frame. In some examples, one sample may be configured to store a geometry slice header (i.e. a geometry parameter of the slice), a geometry code stream, a property segment (i.e. a property parameter of the slice), and a property code stream of the slice 3 in one media frame. Moreover, an association relation may be established among the slice base track, the slice track 1, and the slice track 2.

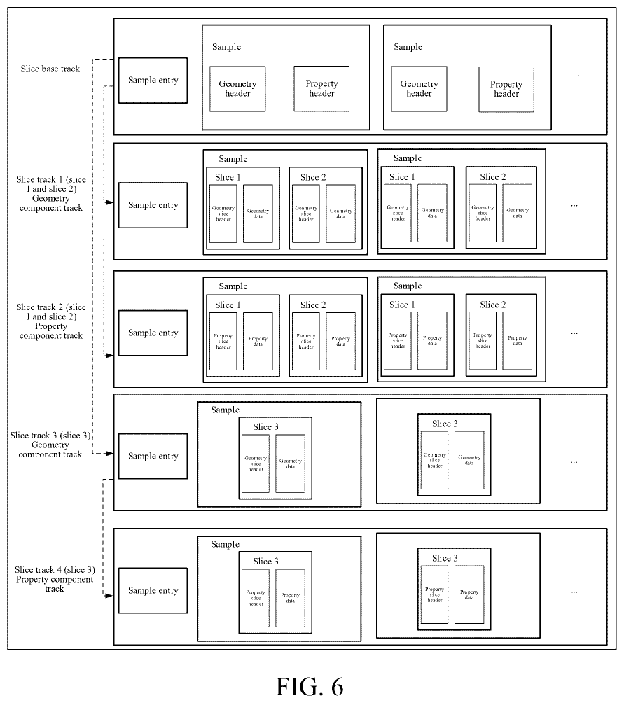

In some examples, as shown in FIG. 6, a schematic diagram of slice based multi-track encapsulation according to an embodiment of this disclosure is shown. As shown in FIG. 6, the slice encapsulation in FIG. 6 is different from the slice encapsulation in FIG. 5 in that geometry data and property data are separately encapsulated. Similarly, the computer device may divide each of the N media frames, so as to obtain a plurality of slices. For example, the computer device divides each media frame into three slices, i.e. a slice 1, a slice 2, and a slice 3. Code stream data corresponding to the N media frames are encapsulated in a plurality of media tracks based on the slices. In some examples, the computer device may encapsulate slice base information of the media frame in a slice base track. The slice base track also includes one sample entry and a plurality of samples. Similarly, the sample entry of the slice base track is configured to store metadata information of samples in the slice base track. One sample in the slice base track is configured to store slice information of one media frame. To be specific, a geometry header (such as a parameter set required for decoding the geometry data) and a property header (for example, a parameter set required for decoding the property data) corresponding to the media frame are encapsulated in each sample.

As shown in FIG. 6, the computer device may encapsulate the geometry data and the property data separately, to be specific, encapsulate geometry data corresponding to a slice 1 and a slice 2 in each media frame respectively in one media track, i.e. a slice track 1; encapsulate property data corresponding to the slice 1 and the slice 2 in each media frame respectively in one media track, i.e. a slice track 2; encapsulate geometry data corresponding to a slice 3 in another media track, i.e. a slice track 3; and encapsulate property data corresponding to the slice 3 in another media track, i.e. a slice track 4. In some examples, the slice track 1 also includes one sample entry and a plurality of samples. The sample entry is configured to encapsulate metadata information of all samples in the slice track 1. Each sample in the slice track 1 is configured to encapsulate the geometry data corresponding to the slice 1 and the slice 2 in the media frame respectively. In some examples, one sample may be configured to store a geometry slice header (i.e. a geometry parameter of the slice) and a geometry code stream of the slice 1 in the media frame and a geometry slice header (i.e. a geometry parameter of the slice) and a geometry code stream of the slice 2 in the one media frame. Similarly, the slice track 2 also includes one sample entry and a plurality of samples. The sample entry is configured to encapsulate metadata information of all samples in the slice track 2. Each sample in the slice track 2 is configured to encapsulate the property data corresponding to the slice 1 and the slice 2 in the one media frame respectively. In some examples, one sample may be configured to store a geometry slice header (i.e. a geometry parameter of the slice) and a geometry code stream of the slice 1 in one media frame and a geometry slice header (i.e. a geometry parameter of the slice) and a geometry code stream of the slice 2 in the one media frame.

Similarly, as shown in FIG. 6, the slice track 3 also includes one sample entry and a plurality of samples. The sample entry is configured to encapsulate metadata information of all samples in the slice track 3. Each sample in the slice track 3 is configured to encapsulate the geometry data corresponding to the slice 3 in one media frame. In some examples, one sample may be configured to store a geometry slice header (i.e. a geometry parameter of the slice) and a geometry code stream of the slice 3 in one media frame. Similarly, the slice track 4 also includes one sample entry and a plurality of samples. The sample entry is configured to encapsulate metadata information of all samples in the slice track 4. Each sample in the slice track 4 is configured to encapsulate the property data corresponding to the slice 3 in one media frame. In some examples, one sample may be configured to store a property slice header (i.e. a property parameter of the slice) and a property code stream of the slice 3 in one media frame. Moreover, an association relation may be established among the slice base track, the slice track 1, the slice track 2, the slice track 3, and the slice track 4.

S102, generate, if the N media frames include media objects, object indication information related to the N media frames.

In some examples, if the N media frames include the media objects, the computer device may generate the object indication information related to the N media frames. The object indication information is configured for indicating object property features corresponding to the media objects included in the N media frames and distribution features of the media objects in the N media frames. The media object may be an article (such as a cup and a chair), a virtual prop, a virtual role, a character, an animal, etc. in the media frame. A media object included in each media frame can be rapidly determined through the object indication information. In this way, a particular media frame (such as a media frame including a particular media object) can be rapidly located; and media data corresponding to the particular media frame can be rapidly acquired. Thus, efficiency of acquiring media data can be improved. The object property feature and the distribution feature of the media object included in each of the N media frames may be obtained by identifying objects in the N media frames at a stage of acquiring the N media frames, or may be obtained by performing algorithm analysis on code stream data corresponding to the N media frames, which is not limited in the embodiment of this disclosure.

In an embodiment, the object property feature in the object indication information may include one or more of an object number, an object identifier, and object description information of the media object included in each of the N media frames. The object identifier may be an object identifier ((OID), i.e. an identifier mechanism standardized by the international telecommunication union (ITU) and the international organization for standardization (ISO)/international electrotechnical commission (IEC), and is configured for naming any object, concept, or “thing” with a definite permanent name globally). Specific object information corresponding to the media object may be determined definitely through the OID. The object description information may be specific object information, described in a form of a character string readable by human eyes, of the media object, such as an object structure, an object color, an object material, and an object function.

In an embodiment, the distribution feature in the object indication information is configured for indicating a target media frame having the media object in the N media frames. To be specific, the distribution feature may be configured for indicating the target media frame to which the media object included in the N media frames belongs. Alternatively, the distribution feature is configured for indicating a target media frame having the media object in the N media frames and a spatial region to which the media object belongs in the target media frame, i.e. a media object included in a spatial region of each media frame. Alternatively, the distribution feature is configured for indicating a target media frame having the media object in the N media frames and a slice to which the media object belongs in the target media frame. Alternatively, the distribution feature is configured for indicating a target media frame having the media object in the N media frames, a spatial region to which the target media frame belongs, and a slice to which the target media frame belongs. The distribution feature may be configured for indicating one or more of the media object included in each media frame, the media object included in the spatial region of each media frame, and the slice in which the media object included in each media frame is located. In this way, media data of a particular media frame (such as a media frame including a particular media object) can be rapidly located through the object indication information related to the N media frames; media data of a particular slice (such as a point cloud slice or video slice including the particular media object) can be rapidly located; and media data of a particular spatial region (such as a spatial region including the particular media object) can be rapidly located. Thus, efficiency of acquiring the media data can be improved.

In an embodiment, the object indication information may be further configured for indicating change features of the media objects included in the N media frames. The change feature herein includes an object change feature and a distribution change feature. The object change feature is determined according to an object property feature of a media object in a reference media frame and an object property feature of a dynamic media frame. The distribution change feature is determined according to a distribution feature of the media object in the reference media frame and a distribution feature of the dynamic media frame. The dynamic media frame, belonging to the N media frames, is a media frame for recording a dynamic picture or a movement procedure, for example, a media frame in movie or television work. The N media frames may further include a static media frame. The static media frame is a media frame for recording a static picture, for example, a game frame. The reference media frame may be a dynamic media frame whose encapsulation ranking is before an encapsulation ranking of the dynamic media frame, and in which the complete object indication information is encapsulated (to be specific, a corresponding metadata track sample is a synchronous metadata track sample).

In an embodiment, when the encapsulated media file related to the N media frames includes a plurality of media files having associated media objects, the object indication information further includes object relation indication information. The object relation indication information is configured for indicating that the plurality of media files having the associated media objects have an association relation. In some examples, the encapsulated media file related to the N media frames includes a first media file and a second media file. The first media file and the second media file may be sub-files in the encapsulated media file. Each of the first media file and the second media file may be one or more of the media track and the media item in the encapsulated media file. When a media object in a media frame corresponding to the first media file has an association relation with a media object in a media frame corresponding to the second media file, the object indication information may further include the object relation indication information. The object relation indication information is configured for indicating that the media object in the media frame corresponding to the first media file has the association relation with the media object in the media frame corresponding to the second media file. In some examples, in the presence of the association relation, the media object in the media frame corresponding to the first media file may be identical to the media object in the media frame corresponding to the second media file. Alternatively, in the presence of the association relation, the media object in the media frame corresponding to the first media file may have a binding relation, an associated movement relation, an associated display relation, etc. with the media object in the media frame corresponding to the second media file. In this way, the media data having the association relation can be rapidly acquired through the object relation indication information, so that efficiency of acquiring the particular media data can be improved.

In an embodiment, when code stream data corresponding to the N media frames are encapsulated in the media track, the object indication information may further include track object indication information belonging to each media track object. The track object indication information is configured for indicating an object property feature of a media object in a media frame belonging to a corresponding media track, i.e. an object property feature of a media object included in each media track. In this way, a media track satisfying a condition (for example, a media track including the particular media object or a media track including no media object) can be rapidly located, so that efficiency of acquiring the particular media data can be improved.

In an embodiment, when code stream data corresponding to the N media frames are encapsulated in the media item, the object indication information may further include item object indication information corresponding to each media item. The item object indication information is configured for indicating an object property feature of a media object in a media frame corresponding to the media item, i.e. an object property feature of a media object included in each media item. In this way, a media item satisfying a condition (for example, a media item including the particular media object or a media item including no media object) can be rapidly located, so that efficiency of acquiring the particular media data can be improved.

S103, transmit the encapsulated media file and the object indication information to the decoding device.

In some examples, the computer device may transmit the encapsulated media file and the object indication information to the decoding device. The decoding device may acquire a to-be-decoded media file segment from the encapsulated media file based on the object indication information, and decode the to-be-decoded media file segment, so as to obtain media data corresponding to the to-be-decoded media file segment. In this way, the to-be-decoded media file segment can be rapidly acquired from the encapsulated media file based on the object indication information, and only the to-be-decoded media file segment needs to be decoded (to be specific, only a part of the media file needs to be decoded, so that a number of to-be-decoded data can be decreased). Thus, the particular media data can be rapidly acquired and demonstrated, and efficiency of acquiring the particular media data can be improved.

In an embodiment, the computer device may directly transmit the encapsulated media file and the object indication information to the decoding device.

In an embodiment, the operation that the computer device transmits the encapsulated media file and the object indication information to the decoding device may include the following operations: If the encapsulated media file includes S media file segments, object indication information associated with the S media file segments respectively is extracted from the object indication information, S being an integer greater than 1. Object indication information associated with a media file segment i in the S media file segments is encapsulated in the media file segment i, so as to obtain a target media file segment i, S being an integer greater than 1, and i being a positive integer less than or equal to S. The object indication information associated with the S media file segments respectively and segment identifiers corresponding to the S media file segments respectively are transmitted to the decoding device. If an acquisition request for the target media file segment i is received, the target media file segment i is transmitted to the decoding device, the acquisition request being generated by the decoding device based on the object indication information and the segment identifiers associated with the S media file segments respectively.

In some examples, when the encapsulated media file includes the S media file segments, the object indication information may include the object indication information corresponding to the S media file segments respectively. The computer device may extract the object indication information associated with the S media file segments respectively from the object indication information related the N media frames. With the media file segment i in the S media file segments as an example, i being a positive integer less than or equal to S, the object indication information associated with the media file segment i is configured for indicating an object property feature and a distribution feature of a media object included in a media frame corresponding to the media file segment i. The computer device may encapsulate the object indication information associated with the media file segment i in the media file segment i, so as to obtain a target media file segment i. The computer device may transmit to the object indication information associated with the S media file segments respectively and the segment identifiers corresponding to the S media file segments respectively to the decoding device. The decoding device may request a required media file segment from the S media file segments based on the object indication information associated with the S media file segments respectively and the segment identifiers corresponding to the S media file segments respectively.

Further, the computer device may receive an acquisition request for the target media file segment i. The acquisition request may indicate that the decoding device determines that the media file segment i is the required media file segment based on the object indication information and the segment identifiers associated with the S media file segments respectively, and generates the acquisition request based on a segment identifier corresponding to the media file segment i. The computer device may transmit the target media file segment i to the decoding device. In this way, the object indication information is transmitted to the decoding device. The decoding device requests the required media file segment from the encoding device, instead of transmitting the encapsulated media file to the decoding device at a time. Thus, pressure of transmitting the media file can be reduced, and efficiency of transmitting the media file can be improved. Also, the decoding device may decode only the target media file segment. Thus, a number of to-be-decoded media data can be decreased, and efficiency of acquiring the particular media data can be improved.

When transmitting the object indication information associated with the S media file segments respectively and the segment identifiers corresponding to the S media file segments respectively to the decoding device, the computer device may generate a dynamic adaptive streaming over HTTP (DASH) based on the object indication information associated with the S media file segments respectively and the segment identifiers corresponding to the S media file segments respectively; and transmit the dynamic adaptive streaming over HTTP to the decoding device. Thus, the S media file segments are transmitted progressively (to be specific, a requested media file segment is transmitted only when requested by the decoding device). The dynamic adaptive streaming over HTTP includes an object information descriptor. The object information descriptor is configured for describing an object property feature of a media object included in a media resource (such as a media file segment) corresponding to each adaptation set. The adaptation set may be a set of one or more video streams in the DASH. One adaptation set may include a plurality of representations. The representation indicates a combination of one or more media components in the DASH. For example, a video file in a resolution may be deemed as one representation. For example, one adaptation set may be configured for indicating one or more media file segments. The object information descriptor is a supplemental property element, with its @schemeIdUri property set to “urn:avs:pccs:2023:obif”.

Reference can be made to Table 1 for elements and properties included in the object information descriptor.

TABLE 1

| Element and Property | Use | Data Type | Description |
|---|---|---|---|
| obif | 0 . . . 1 | avspcc: objectInfoType | It is a container element with |
| | | | a property and element |
| | | | specifying object indication |
| | | | information. |
| obif@oidFlag | M | xs: bool | When set to 0, it indicates |
| | | | that object description |
| | | | information in a current data |
| | | | box is indicated in a form of a |
| | | | character string readable by |
| | | | human eyes. When set to 1, it |
| | | | indicates that object |
| | | | description information in a |
| | | | current data box is indicated |
| | | | in a form of an OID. |
| obif.objectInfoStruct | 1 . . . N | obif: objectInfoStructType | It is an element with a |
| | | | property defining a media |
| | | | object entry. |
| obif.objectInfoStruct@objectInfold | M | xs: unsignedInt | It is an identifier of the media |
| | | | object entry. |
| obif.objectInfoStruct@oid | OD | xs: string | It indicates an OID of an |
| | | | article corresponding to the |
| | | | media object entry. When |
| | | | @oidFlag is set 1, the |
| | | | element is required, otherwise |
| | | | the element is not to be |
| | | | present. |
| obif.objectInfoStruct@objectLabel | OD | xs: string | It indicates a human eye- |
| | | | readable tag of a media object |
| | | | corresponding to the media |
| | | | object entry. When @oidFlag |
| | | | is set 0, the element is |
| | | | required, otherwise the |
| | | | element is not to be present. |

A media resource corresponding to a metadata track is to exist in a form of an independent adaptation set in the DASH, and the adaptation set has only one representation (i.e. one media combination). The representation is to be associated with one or more representations corresponding to the media track described by the metadata track through an element @associationId (an association element), and a corresponding @associationType field is to be set to ‘obdi’.

In an embodiment, the operation that the computer device transmits the encapsulated media file and the object indication information to the decoding device may include the following operations: The computer device may encapsulate the object indication information in the encapsulated media file, so as to obtain a target media file, and transmit the target media file to the decoding device. In this way, the decoding device may acquire the to-be-decoded media file segment from the encapsulated media file of the target media file based on the object indication information in the target media file, and decode the to-be-decoded media file segment, so as to obtain media data corresponding to the to-be-decoded media file segment. In this way, the to-be-decoded media file segment can be rapidly acquired from the encapsulated media file based on the object indication information, and only the to-be-decoded media file segment needs to be decoded (to be specific, only a part of the media file needs to be decoded, so that a number of to-be-decoded data can be decreased). Thus, the particular media data can be rapidly acquired and demonstrated, and efficiency of acquiring the particular media data can be improved.

In an embodiment, the N media frames include K dynamic media frames having media objects, and the encapsulated media file includes P media tracks to which the K dynamic media frames belong, P being a positive integer, and K being a positive integer less than or equal to N. The encapsulated media file includes the P media tracks obtained by encapsulating code stream data corresponding to the K dynamic media frames. For example, one media track may be obtained by encapsulating code stream data corresponding to the K dynamic media frames in a single-track encapsulation mode. A plurality of media tracks may be obtained by encapsulating code stream data corresponding to the K dynamic media frames in a component based multi-track encapsulation mode. The operation that the computer device transmits the encapsulated media file and the object indication information to the decoding device may include the following operations: An object property feature and a distribution feature of a media object included in a dynamic media frame belonging to a media track j are acquired from the object indication information, j being a positive integer less than or equal to P. The object property feature of the media object in the dynamic media frame belonging to the media track j is encapsulated in an object information data box j associated with the media track j. The object property feature and the distribution feature of the media object included in the dynamic media frame belonging to the media track j are encapsulated in a metadata track corresponding to the media track j. Object information data boxes and metadata tracks corresponding to the P media tracks respectively are added to the encapsulated media file, so as to obtain a target media file, and the target media file is transmitted to the decoding device.

In some examples, the computer device may acquire the object property feature and the distribution feature of the media object included in the dynamic media frame belonging to the media track j from the object indication information, the media track j belonging to any one of the P media tracks. Further, the computer device may take the object property feature of the media object in the dynamic media frame belonging to the media track j as track object indication information corresponding to the media track j, and encapsulate the track object indication information corresponding to the media track j in the object information data box associated with the media track j. Each media track has an associated object information data box. The object information data box is configured to encapsulate the object property feature and the distribution feature of the media object included in the media frame belonging to the corresponding media track.

A data box type of the object information data box may be “obif (a data box type)”. The object information data box may be included in a sample entry of the track, and one or more object information data boxes may be provided. The computer device may set whether a compulsory characteristic of the object information data box is a non-compulsory characteristic. Reference can be made to Table 2 for the specific content that the computer device encapsulates the track object indication information corresponding to the media track j in the object information data box associated with the media track j.

```
TABLE 2
aligned (8) class ObjectInfoBox extends FullBox (‘obif’, version = 0, 0) {
  unsigned int (16) num_objects;
unsigned int (1) object_oid_flag;
  bit (7) reserved;
for (i=0; i<num_objects; i++){
  unsigned int (16) object_info_id;
    if (object_oid_flag == 1) {
  string object_oid;
}
else {
  string object_label;
}
}
```

In Table 2, num_objects indicates a number of media object entries included in a current object information data box. When set to 0, object_oid_flag indicates that object description information related to the media object in the current object information data box is indicated in a form of a character string readable by human eyes. To be specific, the object description information of the media object is indicated in the form of the character string readable by the human eyes. When set to 1, object_oid_flag indicates that object description information related to the media object in the current object information data box is indicated in a form of an OID. To be specific, the object description information of the media object is indicated in the form of the OID. In Table 2, object_info_id indicates an identifier (i.e. an object identifier) of a corresponding media object entry, and object_oid indicates object description information corresponding to the corresponding media object entry and is indicated in a form of an OID; and object_label indicates article description information corresponding to the corresponding media object entry and is indicated in a form of a character string readable by human eyes.

In an embodiment, object_label may employ an implementation as follows: a character string object_label includes N labels of different levels, and labels of each level are separated by space. For example: object_label1: “horse head” object_label2: “horse body”, etc.

Moreover, the computer device encapsulates the object property feature and the distribution feature of the media object included in the dynamic media frame belonging to the media track j in a metadata track corresponding to the media track j. The object property feature and the distribution feature of the media object included in the dynamic media frame may be taken as a media type and included in the media file in a form of the metadata track. Further, the computer device may add the object information data boxes and the metadata tracks corresponding to the P media tracks respectively to the encapsulated media file, so as to obtain the target media file, and transmit the target media file to the decoding device.

In an embodiment, the metadata track corresponding to the media track j includes metadata track samples corresponding to the dynamic media frames belonging to the media track j respectively. To be specific, one dynamic media frame corresponds to one metadata track sample in the metadata track. When encapsulating the object property feature and the distribution feature of the media object included in the dynamic media frame belonging to the media track j in the metadata track corresponding to the media track j, the computer device may encapsulate an object property feature and a distribution feature of a media object included in each dynamic media frame in a corresponding metadata track sample. Certainly, the computer device or may encapsulate a change feature between the object property feature of the media object included in each dynamic media frame and the object property feature of the media object included in the reference media frame, and a change feature between the distribution feature of the media object included in each dynamic media frame and the distribution feature of the media object included in the reference media frame in a corresponding metadata track sample.

In an embodiment, the operation that the computer device encapsulates an object property feature and a distribution feature of a media object included in each dynamic media frame in a corresponding metadata track sample may include the following operations: An object property feature and a distribution feature of a media object included in a dynamic media frame a belonging to the media track j are added to a metadata track sample corresponding to the dynamic media frame a, a being less than or equal to a total number of the dynamic media frames belonging to the media track j.

The computer device may encapsulate the object property feature and the distribution feature of the media object included in each dynamic media frame belonging to the media track j in one metadata track sample in the metadata track corresponding to the media track j. In some examples, with the dynamic media frame a belonging to the media track j as an example, a being less than or equal to the total number of the dynamic media frames belonging to the media track j, the computer device may add the object property feature and the distribution feature of the media object included in the dynamic media frame a belonging to the media track j to the metadata track sample corresponding to the dynamic media frame a. In this case, when the computer device may encapsulate complete object indication information included in the dynamic media frame a belonging to the media track j in the metadata track sample corresponding to the dynamic media frame a, the metadata track sample corresponding to the dynamic media frame a may be a synchronous metadata track sample. To be specific, the synchronous metadata track sample is configured to indicate the complete object indication information included in the corresponding dynamic media frame. In this way, the object property feature and the distribution feature of the media object included in the corresponding dynamic media frame may be acquired through the synchronous metadata track sample.

In some examples, reference can be made to Table 3 for the specific content that the computer device encapsulates complete object indication information included in the dynamic media frame a belonging to the media track j in the metadata track sample (i.e. the synchronous metadata track sample) corresponding to the dynamic media frame a.

```
TABLE 3
aligned (8) class ObjectInfoSampleEntry extends
MetaDataSampleEntry (‘obdi’)
{
ObjectInfoBox ( );
}
aligned (8) ObjectInfoSample ( ) {
unsigned int (16) num_object;
for (i = 0; i < num_object; i ++) {
unsigned int (16) ref_object_info_id;
unsigned int (1) object_spatial_info_flag;
unsigned int (1) object_slice_info_flag;
bit (6) reserved;
if (object_spatial_info_flag == 1) {
  3DPoint ( ) anchor;
CuboidRegionStruct ( ) cuboidRegion;
}
if (object_slice_info_flag) {
    SliceMapping ( ) slice_info;
}
}
}
```

In Table 3, num_object indicates a number of media object entries included in the current metadata track sample (i.e. a number of the media object). When set to 0, a num_object field indicates that the current metadata track sample includes no media object entry. In Table 3, ref_object_info_id is configured for indicating an identifier corresponding to the media object entry (i.e. an object identifier of the media object); when set to 0, object_spatial_info_flag indicates that no specific spatial region information corresponding to the media object is indicated; when set to 1, object_spatial_info_flag indicates that specific spatial region information corresponding to the media object is indicated; and when set to 0, object_slice_info_flag indicates that no slice information (such as point cloud slice information) corresponding to the media object is indicated, and when set to 1, object_slice_info_flag indicates that slice information corresponding to the media object is indicated. 3DPoint is configured for indicating anchor coordinates corresponding to a spatial region, CuboidRegionStruct is configured for indicating size information corresponding to the spatial region, and SliceMapping is configured for indicating corresponding slice information.

In an embodiment, the metadata track corresponding to the media track j includes metadata track samples corresponding to the dynamic media frames belonging to the media track j respectively. The operation that the computer device encapsulates a change feature between the object property feature of the media object included in each dynamic media frame and the object property feature of the media object included in the reference media frame, and a change feature between the distribution feature of the media object included in each dynamic media frame and the distribution feature of the media object included in the reference media frame in a corresponding metadata track sample may include the following operations: An object property feature and a distribution feature of a media object in a reference media frame corresponding to the dynamic media frame a are acquired, a being less than or equal to the total number of the dynamic media frames belonging to the media track j. An object change feature between the object property feature of the media object in the reference media frame and the object property feature of the dynamic media frame a is determined. A distribution change feature between the distribution feature of the media object in the reference media frame and the distribution feature of the dynamic media frame a is determined, and the object change feature and the distribution change feature are added to the metadata track sample corresponding to the dynamic media frame a. In this way, only the change features are stored to avoid repeated storage, so that a number of to-be-stored data can be decreased, and storage pressure can be reduced.

The computer device may take a dynamic media frame having an encapsulation ranking before an encapsulation ranking of the dynamic media frame a and encapsulating the complete object indication information (to be specific, the corresponding metadata track sample is the synchronous metadata track sample) as the reference media frame of the dynamic media frame a. The computer device may determine the object change feature between the object property feature of the media object in the reference media frame and the object property feature of the dynamic media frame a according to the object property feature and the distribution feature of the media object in the reference media frame corresponding to the dynamic media frame a. For example, the object change feature may be configured for indicating whether the media object included in the dynamic media frame a also exists in the reference media frame, or whether the object description information is changed (for example, a color or a structure are changed). Moreover, the computer device may determine the distribution change feature between the distribution feature of the media object in the reference media frame and the distribution feature of the dynamic media frame a. The distribution change feature may be configured for indicating change information of a spatial region or slice in which the media object is distributed. For example, the distribution change feature may be information between spatial region information and slice information of a media object Y01 in the dynamic media frame a and spatial region information and slice information of the media object Y01 in the reference media frame. Further, the computer device may add the object change feature and the distribution change feature to the metadata track sample corresponding to the dynamic media frame a.

In some examples, reference can be made to Table 4 for the specific content that the computer device encapsulates a change feature between the object property feature of the media object included in each dynamic media frame and the object property feature of the media object included in the reference media frame, and a change feature between the distribution feature of the media object included in each dynamic media frame and the distribution feature of the media object included in the reference media frame in a corresponding metadata track sample (i.e. a non-synchronous metadata track sample).

```
TABLE 4
aligned (8) class ObjectInfoSampleEntry extends
MetaDataSampleEntry (‘obdi’)
{
ObjectInfoBox ( );
}
aligned (8) ObjectInfoSample ( ) {
unsigned int (16) num_object_update;
for (i = 0; i<num_object_update; i ++) {
unsigned int (16) ref_object_info_id;
unsigned int (1) object_canceled_flag;
unsigned int (1) object_spatial_info_flag
unsigned int (1) object_slice_info_flag;
bit (5) reserved;
if (object_canceled_flag == 0) {
if (object_spatial_info_flag == 1) {
  3DPoint ( ) anchor;
CuboidRegionStruct ( ) cuboidRegion;
}
if (object_slice_info_flag) {
    SliceMapping ( ) slice_info;
}
}
}
```

In Table 4, num_object_update indicates a number of entries of an either object included in the current metadata track sample changing with respect to the synchronous metadata track sample corresponding to the reference media frame. When set to 0, a num_object_update field indicates that the media object included in the current metadata track sample is identical to the synchronous metadata track sample corresponding to the reference media frame. In Table 4, when set to 1, object_canceled_flag indicates that the corresponding media object is no longer included in the current metadata track sample; when set to 0, object_canceled_flag indicates that the corresponding media object is included in the current metadata track sample but is updated; when set to 0, object_spatial_info_flag indicates that no specific spatial region information corresponding to the media object is indicated; when set to 1, object_spatial_info_flag indicates that specific spatial region information corresponding to the media object is indicated; and when set to 0, object_slice_info_flag indicates that no slice information (such as point cloud slice information) corresponding to the media object is indicated, and when set to 1, object_slice_info_flag indicates that slice information corresponding to the media object is indicated. 3DPoint is configured for indicating anchor coordinates corresponding to a spatial region, CuboidRegionStruct is configured for indicating size information corresponding to the spatial region, and SliceMapping is configured for indicating corresponding slice information.

In an embodiment, the operation that the computer device adds object information data boxes and metadata tracks corresponding to the P media tracks respectively to the encapsulated media file, so as to obtain the target media file may include the following operations: The object information data box j is added to a track sample entry of the media track j. The metadata tracks corresponding to the P media tracks respectively are added to the encapsulated media file, so as to obtain the target media file.

In some examples, the computer device may add each object information data box to a track sample entry of a corresponding media track. In some examples, with the object information data box j as an example, the computer device may add the object information data box j to the track sample entry of the media track j. In this way, through the object information data box in the track sample entry of each media track, the object property feature of the media object included in the media frame belonging to the media track can be acquired. For example, a media track satisfying a condition can be rapidly located through the object information data box in the track sample entry of each media track. For example, the media track satisfying the condition may be a media track including a particular media object. Alternatively, the media track satisfying the condition may be a media track including no media object. It can be seen that efficiency of acquiring the media data can be improved. Moreover, the computer device may add the metadata tracks corresponding to the P media tracks respectively to the encapsulated media file, so as to obtain the target media file. Since the object property feature and the distribution feature of the media object included in the media frame belonging to each media track is encapsulated in the metadata track corresponding to each of the P media tracks, a media frame satisfying a condition (such as a media frame including a particular media object or a media frame including no media object) can be rapidly located through the metadata track; a spatial region in a media frame satisfying a condition can be rapidly located; and alternatively, a slice corresponding to a media frame satisfying a condition can be rapidly located. It can be seen that efficiency of acquiring the media data can be improved through the metadata track.

In an embodiment, the operation that the computer device adds object information data boxes and metadata tracks corresponding to the P media tracks respectively to the encapsulated media file, so as to obtain the target media file may include the following operations: The object information data box j is added to a track sample entry of the metadata track corresponding to the media track j, so as to obtain an added metadata track corresponding to the media track j. Added metadata tracks corresponding to the P media tracks respectively are added to the encapsulated media file, so as to obtain the target media file.

In some examples, since each media track has an association relation with a corresponding metadata track, the computer device may also add an object information data box corresponding to each media track to the corresponding metadata track. In some examples, with the object information data box j as an example, the computer device may add the object information data box j to the track sample entry of the metadata track corresponding to the media track j, so as to obtain the added metadata track corresponding to the media track j. The added metadata tracks corresponding to the P media tracks respectively are added to the encapsulated media file, so as to obtain the target media file. In this way, a metadata track satisfying a condition (for example, a metadata track including a particular media object) can be rapidly located through an object information data box in the track sample entry of the metadata track corresponding to each media track. Further, a media frame satisfying a condition (such as a media frame including a particular media object or including no media object) can be rapidly located according to the object property feature and the distribution feature of the media object included in each dynamic media frame encapsulated in the metadata track; a spatial region in a media frame satisfying a condition can be rapidly located; and alternatively, a slice corresponding to a media frame satisfying a condition can be rapidly located. It can be seen that efficiency of acquiring the media data can be improved through the metadata track.

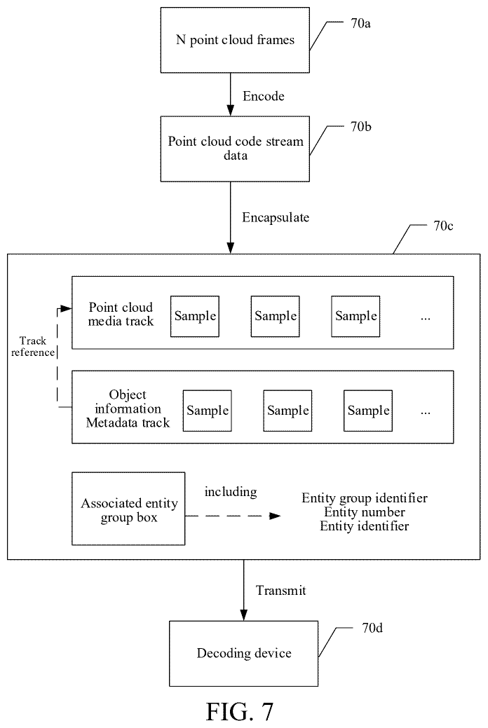

As shown in FIG. 7, a schematic diagram of a target media file according to an embodiment of this disclosure is shown. As shown in FIG. 7, with a media frame being a point cloud frame as an example, after acquiring N point cloud frames 70a, the computer device may encode the N point cloud frames 70a, so as to obtain point cloud code stream data 70b corresponding to the N point cloud frames 70a. Further, the computer device may encapsulate the point cloud code stream data 70b, so as to obtain a target media file 70c. As shown in FIG. 7, the target media file includes a point cloud media track, an object information metadata track, and an associated entity group box. The object information metadata track is to be associated with a point cloud media track described by the object information metadata track through a track reference in a ‘cdsc’ type. In some examples, the computer device may encapsulate the point cloud code stream data 70b in the point cloud media track. Moreover, the computer device may acquire object indication information related to the N point cloud frames, and encapsulate the object indication information related to the N point cloud frames in the object information metadata track corresponding to the point cloud media track. Object indication information of one point cloud frame is encapsulated in one sample in the object information metadata track. Moreover, the object indication information may further include object relation indication information. The object relation indication information is configured for indicating media files having an association relation and is encapsulated in an associated entity group. For example, an encapsulated media file (i.e. the point cloud media track) obtained by encapsulating the point cloud code stream data 70b includes a point cloud media track G03 and a point cloud media track G04. Point cloud frames corresponding to the point cloud media track G03 and the point cloud media track G04 respectively include identical media objects or include associated media objects. Moreover, when an object information metadata track Y03 corresponding to the point cloud media track G03 and an object information metadata track Y04 corresponding to the point cloud media track G04 exist, the object relation indication information includes an associated entity group configured for indicating that the point cloud media track G03 has an association relation with the object information metadata track Y03, and the point cloud media track G04 has an association relation with the object information metadata track Y04. The associated entity group includes an entity group identifier such as Z01, a number of entities (to be specific, four entities are provided), and entity identifiers (i.e. G03, G04, Y03, and Y04) corresponding to the point cloud media track G03, the point cloud media track G04, the object information metadata track Y03, and the object information metadata track Y04 respectively. Further, the computer device may transmit the target media file 70c corresponding to the N point cloud frames to the decoding device 70d.

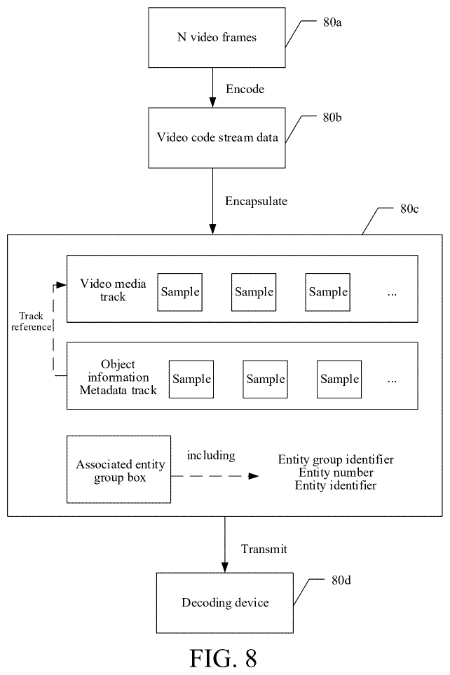

As shown in FIG. 8, a schematic diagram of a target media file according to an embodiment of this disclosure is shown. As shown in FIG. 8, with a media frame being a video frame as an example, after acquiring N video frames 80a, the computer device may encode the N video frames 80a, so as to obtain video code stream data 80b corresponding to the N video frames 80a. Further, the computer device may encapsulate the video code stream data 80b, so as to obtain a target media file 80c. As shown in FIG. 8, the target media file includes a video media track, an object information metadata track, and an associated entity group box. The object information metadata track is to be associated with the video media track described by the object information metadata track through a track reference in a ‘cdsc’ type. In some examples, the computer device may encapsulate the video code stream data 80b in the video media track. Moreover, the computer device may acquire object indication information related to the N video frames, and encapsulate the object indication information related to the N video frames in the object information metadata track corresponding to the video media track. Object indication information of one video frame is encapsulated in one sample in the object information metadata track. Moreover, the object indication information may further include object relation indication information. The object relation indication information is configured for indicating media files having an association relation and is encapsulated in an associated entity group. For example, the encapsulated media file (i.e. the video media track) obtained by encapsulating the video code stream data 80b includes a video media track G05 and a video media track G06. Video frames corresponding to the video media track G05 and the video media track G06 respectively include identical media objects or associated media objects. Moreover, when an object information metadata track Y05 corresponding to the video media track G05 and an object information metadata track Y06 corresponding to the video media track G06 exist, the object relation indication information includes an associated entity group used for indicating that the video media track G05 has an association relation with the object information metadata track Y05, and the video media track G06 has an association relation with the object information metadata track Y06. The associated entity group includes an entity group identifier such as Z02, a number of entities (to be specific, four entities are provided), and entity identifiers (i.e. G05, G06, Y05, and Y06) corresponding to the video media track G05, the video media track G06, the object information metadata track Y05, and the object information metadata track Y06 respectively. Further, the computer device may transmit the target media file 80c corresponding to the N video frames to the decoding device 80d.

In an embodiment, the N media frames include Q static media frames including media objects, and the encapsulated media file includes Q media items corresponding to the Q static media frames, Q being a positive integer less than or equal to N. The operation that the computer device transmits the encapsulated media file and the object indication information to the decoding device may include the following operations: An object property feature and a distribution feature of a media object in a static media frame corresponding to a media item r are acquired from the object indication information, r being a positive integer less than or equal to Q. The object property feature and the distribution feature of the media object in the static media frame corresponding to the media item r are encapsulated in an item property box associated with the media item r. Item property boxes corresponding to the Q media items respectively are added to the encapsulated media file, so as to obtain a target media file, and the target media file is transmitted to the decoding device.

In some examples, when encapsulating code stream data corresponding to the N media frames, the computer device may encapsulate code stream data corresponding to the Q static media frames having the media objects in the N media frames as the media items. To be specific, the encapsulated media file includes the Q media items corresponding to the Q static media frames, and the object indication information includes an object property feature and a distribution feature of a media object included in each static media frame. In some examples, the computer device may acquire the object property feature and the distribution feature of the media object in the static media frame corresponding to the media item r from the object indication information, and encapsulate the object property feature and the distribution feature of the media object in the static media frame corresponding to the media item r in the item property box associated with the media item r. In this way, a media item satisfying a condition can be rapidly located through the item property box associated with each media item; moreover, a spatial region in a media frame satisfying a condition can be rapidly located; and alternatively, a slice corresponding to a media frame satisfying a condition can be rapidly located. It can be seen that efficiency of acquiring media data can be improved through the item property box.

A data box type of the item property box may be “obip (a data box type)”, and a property type of the item property box may be a descriptive item property. The item property box may be included in an item property container box, and each media item corresponds to no or one item property box. The computer device may set a compulsory characteristic corresponding to the item property box to a non-compulsory characteristic. To be specific, the item property box may exist or not.

In some examples, reference can be made to Table 5 for the specific content that the computer device encapsulates the object property feature and the distribution feature of the media object in the static media frame corresponding to the media item r in the item property box associated with the media item r.

```
TABLE 5
aligned (8) class ObjectInfoProperty extends ItemFullProperty (‘obip’, 0, 0) {
unsigned int (16) num_objects;
unsigned int (1) object_oid_flag;
bit (7) reserved;
for (i=0; i<num_objects; i++){
unsigned int (16) object_info_id;
if (object_oid_flag == 1) {
string object_oid;
}
else {
string object_label;
}
unsigned int (1) object_spatial_info_flag;
unsigned int (1) object_slice_info_flag;
bit (6) reserved;
if (object_spatial_info_flag == 1) {
  3DPoint ( ) anchor;
CuboidRegionStruct ( ) cuboidRegion;
}
if (object_slice_info_flag) {
    SliceMapping ( ) slice_info;
}
}
}
```

In Table 5, num_objects indicates a number of media object entries included in a current object information data box. When set to 0, object_oid_flag indicates that object description information related to the media object in the current object information data box is indicated in a form of a character string readable by human eyes. To be specific, the object description information of the media object is indicated in the form of the character string readable by the human eyes. When set to 1, object_oid_flag indicates that object description information related to the media object in the current object information data box is indicated in a form of an OID. To be specific, the object description information of the media object is indicated in the form of the OID. In Table 5, object_info_id indicates an identifier (i.e. an object identifier) of a corresponding media object entry, and object_oid indicates object description information corresponding to the corresponding media object entry and is indicated in a form of an OID; and object_label indicates article description information corresponding to the corresponding media object entry and is indicated in a form of a character string readable by human eyes. When set to 0, object_spatial_info_flag indicates that no specific spatial region information corresponding to the media object is indicated. When set to 1, object_spatial_info_flag indicates that specific spatial region information corresponding to the media object is indicated. When set to 0, object_slice_info_flag indicates that no slice information (such as point cloud slice information) corresponding to the media object is indicated, and when set to 1, object_slice_info_flag indicates that slice information corresponding to the media object is indicated. 3DPoint is configured for indicating anchor coordinates corresponding to a spatial region, CuboidRegionStruct is configured for indicating size information corresponding to the spatial region, and SliceMapping is configured for indicating corresponding slice information.

In an embodiment, the encapsulated media file of the N media frames includes a first media file and a second media file. When a media object in a media frame corresponding to a first media file segment has an association relation with a media object in a media frame corresponding to a second media file segment, the object indication information includes object relation indication information. The object relation indication information is configured for indicating that a media object in a media frame corresponding to the first media file has an association relation with a media object in a media frame corresponding to the second media file. The object indication information includes an object property feature and an object distribution feature of the media object in the media frame corresponding to the first media file, and an object property feature and an object distribution feature of the media object in the media frame corresponding to the second media file. In this case, the operation that the computer device transmits the encapsulated media file and the object indication information to the decoding device may include the following operations: The object relation indication information is encapsulated in an associated entity group box. The object property feature and the object distribution feature of the media object in the media frame corresponding to the first media file are encapsulated in the first media file. The object property feature and the object distribution feature of the media object in the media frame corresponding to the second media file are encapsulated in the second media file. The associated entity group box, the encapsulated first media file, and the encapsulated second media file are determined as a target media file, and the target media file is transmitted to the decoding device.

In some examples, the object indication information further includes object relation indication information, and the object relation indication information is configured for indicating a plurality of media files including media objects having the association relation. For example, if media frames corresponding to a plurality of media file segments in the encapsulated media file respectively include identical media objects, the object relation indication information may be configured for indicating that the plurality of media files including the identical media objects have an association relation. In some examples, with the encapsulated media file including the first media file and the second media file as an example, the object indication information includes the object property feature and the object distribution feature of the media object in the media frame corresponding to the first media file, and the object property feature and the object distribution feature of the media object in the media frame corresponding to the second media file. When the media object in the media frame corresponding to the first media file has the association relation with the media object in the media frame corresponding to the second media file, the object indication information further includes the object relation indication information. The object relation indication information is configured for indicating that the media object in the media frame corresponding to the first media file has the association relation with the media object in the media frame corresponding to the second media file. The computer device may encapsulate the object relation indication information in the associated entity group box.

In some examples, the computer device may indicate the first media file and the second media file that have the association relation and generate the associated entity group based on the object relation indication information. For example, the associated entity group includes file identifiers of the first media file and the second media file, and file numbers of the first media file and the second media file. Further, the computer device may add the associated entity group to the associated entity group box. Each of the first media file and the second media file may be one or more media file segments in the encapsulated media file or any media track or media item in the encapsulated media file. The associated entity group may include one or more of a media track, a media item, and a metadata track corresponding to each of the first media file and the second media file.

For example, the first media file includes a media track G01, and an object property feature and a distribution feature of a media object included in a media frame belonging to the media track G01 are encapsulated in a metadata track Y01 corresponding to the media track G01. The second media file includes a media track G02, and an object property feature and a distribution feature of a media object included in a media frame belonging to the media track G02 are encapsulated in a metadata track Y02 corresponding to the media track G02. The computer device may generate the associated entity group based on the media track G01, the metadata track Y01, the media track G02, and the metadata track Y02. For example, the associated entity group includes identifiers corresponding to the media track G01, the metadata track Y01, the media track G02, and the metadata track Y02 respectively, and a total number of the media track G01, the metadata track Y01, the media track G02, and the metadata track Y02. A data box type of the associated entity group box may be “obje (a data box type)”, and the associated entity group box is included in a groups list box (an entity group list box). One or more associated entity group boxes may be provided. The computer device may set a compulsory characteristic corresponding to the associated entity group box to be a non-compulsory characteristic. To be specific, the associated entity group box may exist or not.

In some examples, reference can be made to Table 6 for the specific content that the computer device encapsulates the object relation indication information in the associated entity group box.

```
TABLE 6
aligned (8) class ObjectInfoAssociationEntityToGroups
Box extends EntityToGroup Box
(‘obje’, 0, 0) {
unsigned int (32) group_id;
  unsigned int (32) num_entities_in_group;
  for (i = 0; i<num_entities_in_group; i ++) {
    unsigned int (32) entity_id;
  }
}
```

In table 6, group_id indicates an identifier of a current associated entity group, and num_entities_in_group indicates a number of entities (the media track, the metadata track, or the media item) in the current associated entity group. In table 6, entity_id indicates identifiers of the entities (the media track, the metadata track, or the item).

Moreover, the computer device may encapsulate the object property feature and the object distribution feature of the media object in the media frame corresponding in the first media file in the first media file, and encapsulate the object property feature and the object distribution feature of the media object in the media frame corresponding to the second media file in the second media file. Reference can be made to encapsulation contents of object indication information corresponding to the media track and the media item respectively for details. Further, the computer device may determine the associated entity group box, the encapsulated first media file, and the encapsulated second media file as the target media file, and transmit the target media file to the decoding device.

In the embodiment of this disclosure, after acquiring the encapsulated media file corresponding to the N media frames, the encoding device may generate, when the N media files include the media objects, the object indication information related to the N media frames. The object indication information is configured for reflecting the object property features of the media objects included in the N media frames and the distribution features of the media objects in the N media frames. To be specific, the object indication information is configured for reflecting types of the media objects included in the N media frames, the media frames including the media objects, positions for including the media objects of the media frames, etc. The media frame (i.e. the media data) required by the decoding device can be rapidly acquired from the encapsulated media file based on the object indication information. The object indication information and the encapsulated media file are transmitted to the decoding device. The decoding device can rapidly acquire the to-be-decoded media file segment from the encapsulated media file corresponding to the N media frames according to the object indication information. The to-be-decoded media file segment can be a media file segment corresponding to the media data required by the decoding device. Thus, efficiency of acquiring the to-be-decoded media file segment can be improved. Further, the media data (such as the media data required by the decoding device) corresponding to the to-be-decoded media file segment can be obtained by decoding only the to-be-decoded media file segment, instead of decoding an entire media file. Thus, a number of to-be-decoded data can be decreased, efficiency of acquiring the media data can be improved, and resource (such as computing resource) overhead of the decoding device can be reduced.

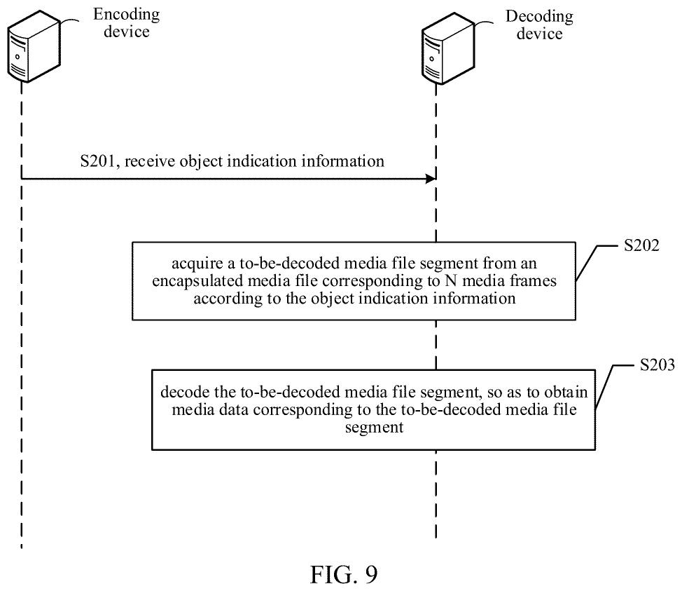

Further, with reference to FIG. 9, a schematic flowchart of a method for processing media data according to an embodiment of this disclosure is shown. As shown in FIG. 9, the method may be performed by the decoding device and may include, but is not limited to, the following operations:

S201, receive object indication information.

In some examples, the computer device may receive the object indication information, the object indication information being configured for reflecting object property features of media objects included in N media frames and distribution features of the media objects in the N media frames, and N being a positive integer. In some examples, the embodiment of this disclosure may be applied to a point cloud data scenario. To be specific, the N media frames may be point cloud frames in the point cloud data. Certainly, the embodiment or may be applied to other types of media scenarios, such as a video data scenario. To be specific, the N media frames may be video frames in video data. The media object may be an article (such as a cup and a chair), a virtual prop, a virtual role, a character, an animal, etc. in the media frame. A media object included in each media frame can be rapidly determined through the object indication information. In this way, a particular media frame (such as a media frame including a particular media object) can be rapidly located, and media data corresponding to the particular media frame can be rapidly acquired. Thus, efficiency of acquiring media data can be improved. The object property feature and the distribution feature of the media object included in each of the N media frames may be obtained by identifying objects in the N media frames at a stage of acquiring the N media frames, or may be obtained by performing algorithm analysis on code stream data corresponding to the N media frames, which is not limited in the embodiment of this disclosure. The object indication information may be transmitted by the encoding device, etc.

In an embodiment, the object property feature in the object indication information may include one or more of an object number, an object identifier, and object description information of the media object included in each of the N media frames. The object identifier may be an object identifier ((OID), i.e. an identifier mechanism standardized by the international telecommunication union (ITU) and the international organization for standardization (ISO)/international electrotechnical commission (IEC), and is configured for naming any object, concept, or “thing” with a definite permanent name globally). Specific object information corresponding to the media object may be determined definitely through the OID. The object description information may be specific object information, described in a form of a character string readable by human eyes, of the media object, such as an object structure, an object color, an object material, and an object function.

In an embodiment, the distribution feature in the object indication information is configured for indicating a target media frame having the media object in the N media frames. To be specific, the distribution feature may be configured for indicating the target media frame to which the media object included in the N media frames belongs. Alternatively, the distribution feature is configured for indicating a target media frame having the media object in the N media frames and a spatial region to which the media object belongs in the target media frame, i.e. a media object included in a spatial region of each media frame. Alternatively, the distribution feature is configured for indicating a target media frame having the media object in the N media frames and a slice to which the media object belongs in the target media frame. Alternatively, the distribution feature is configured for indicating a target media frame having the media object in the N media frames, a spatial region to which the target media frame belongs, and a slice to which the target media frame belongs. The distribution feature may be configured for indicating one or more of the media object included in each media frame, the media object included in the spatial region of each media frame, and the slice in which the media object included in each media frame is located. In this way, media data of a particular media frame (such as a media frame including a particular media object) can be rapidly located through the object indication information related to the N media frames; media data of a particular slice (such as a point cloud slice or video slice including the particular media object) can be rapidly located; and media data of a particular spatial region (such as a spatial region including the particular media object) can be rapidly located. Thus, efficiency of acquiring the media data can be improved.

S202, acquire a to-be-decoded media file segment from the encapsulated media file corresponding to the N media frames according to the object indication information.

In some examples, the computer device may acquire the to-be-decoded media file segment from the encapsulated media file corresponding to the N media frames according to the object indication information. The encapsulated media file corresponding to the N media frames is obtained by encapsulating code stream data corresponding to the N media frames, and the code stream data corresponding to the N media frames are obtained by encoding the N media frames. The encapsulated media file related to the N media frames may be transmitted by the encoding device, and the decoding device acquires the to-be-decoded media file segment from the encapsulated media file based on the object indication information. Since the object indication information indicates the object property features of the media objects included in the N media frames and the distribution features of the media objects in the N media frames, the to-be-decoded media file segment may be acquired from the encapsulated media file corresponding to the N media frames based on the object indication information. In this way, the required media data can be acquired by decoding only the to-be-decoded media file segment, instead of decoding the encapsulated media file corresponding to the N media frames. Thus, a decoding computing amount can be decreased, and efficiency of acquiring the media data (the particular media data) can be improved.

In an embodiment, the to-be-decoded media file segment is code stream data including a target media object; and alternatively, the to-be-decoded media file segment is code stream data including no target media object. The target media object belongs to the media objects in the N media frames. For example, the target media object may be a media object having a target color; alternatively, the target media object may be a media object having a target identifier; alternatively, the target media object may be a media object having a target function; and alternatively, the target media object may be a plurality of media objects having an association relation. The plurality of media objects having an association relation may be, for example, a plurality of media objects having a binding relation or a plurality of media objects displayed or moving jointly. Alternatively, the to-be-decoded media file segment is code stream data including no media object. In this way, the to-be-decoded media file segment is acquired through the object indication information, and only a to-be-decoded media file segment needs to be decoded, so as to obtain the particular media data (such as the media data including the target object, the media data including no target media object, and the media data including no media object). Thus, a number of the to-be-decoded data can be decreased, and efficiency of acquiring the media data can be improved. Moreover, interaction with the target media object is supported based on demonstration of the media data corresponding to the to-be-decoded file.

In an embodiment, the object indication information includes object indication information associated with S media file segments respectively, and the S media file segments belong to the encapsulated media file. The operation that the computer device acquires a to-be-decoded media file segment from the encapsulated media file corresponding to the N media frames according to the object indication information may include the following operations: Segment identifiers corresponding to the S media file segments respectively are acquired. If object indication information of a target media file segment in the S media file segments reflects that the target media file segment satisfies a decoding condition, an acquisition request for the target media file segment is generated according to a segment identifier of the target media file segment. The acquisition request is transmitted to the encoding device, the target media file segment returned by the encoding device based on the acquisition request is received, and the target media file segment is determined as the to-be-decoded media file segment.

In some examples, the encoding device may generate a dynamic adaptive streaming over HTTP according to the object indication information corresponding to the S media file segments respectively and the segment identifiers corresponding to the S media file segments respectively, and transmit the dynamic adaptive streaming over HTTP to the decoding device. The object indication information corresponding to the S media file segments respectively may be configured for indicating object property features of media objects in media frames included in the S media file segments respectively. After acquiring the object indication information corresponding to the S media file segments respectively and the segment identifiers corresponding to the S media file segments respectively from the dynamic adaptive streaming over HTTP, the computer device may determine whether the S media file segments satisfy the decoding condition based on the object indication information corresponding to the S media file segments respectively. If the object indication information of the target media file segment in the S media file segments reflects that the target media file segment satisfies the decoding condition, the acquisition request for the target media file segment is generated according to the segment identifier of the target media file segment.

Further, the computer device may transmit the acquisition request to the encoding device. After receiving the acquisition request for the target media file segment, the encoding device may return the target media file segment to the decoding device. The decoding device may receive the target media file segment returned by the encoding device based on the acquisition request, and determine the target media file segment as the to-be-decoded media file segment. It can be seen that the encoding device only needs to transmit the target media file segment to the decoding device, instead of transmitting the S media file segments. Thus, pressure of data transmission can be reduced, and efficiency of data transmission can be improved. Also, the decoding device can acquire the required media data by decoding only the target media file segment, instead of acquiring the encapsulated media file corresponding to the N media frames and decoding the encapsulated media file. Thus, a number of to-be-decoded data can be decreased, and efficiency of acquiring the media data can be improved.

In an embodiment, the encoding device may directly transmit the object indication information to the decoding device. In an embodiment, the operation that the computer device receives the object indication information transmitted by the encoding device may include the following operations: The target media file transmitted by the encoding device is received, the target media file being obtained after the encoding device adds the object indication information to the encapsulated media file. The computer device may decapsulate the target media file, so as to obtain the object indication information related to the N media frames and the encapsulated media file related to the N media frames.

In an embodiment, the encapsulated media file includes P media tracks to which K dynamic media frames in the N media frames belong, P being a positive integer, and K being a positive integer less than or equal to N. The operation that the computer device acquires a to-be-decoded media file segment from the encapsulated media file corresponding to the N media frames according to the object indication information may include the following operations: From an object information data box j corresponding to a media track j, an object property feature of a media object in a dynamic media frame belonging to the media track j is acquired, j being a positive integer less than or equal to P. A target media track satisfying a decoding condition is determined from the P media tracks according to object property features corresponding to the P media tracks respectively. The to-be-decoded media file segment is determined according to object indication information corresponding to a dynamic media frame belonging to the target media track. The object indication information of the dynamic media frame belonging to the target media track is encapsulated in a metadata track corresponding to the target media track.

In some examples, the encapsulated media file includes the P media tracks to which the K dynamic media frames in the N media frames belong, one media track includes one track sample entry and one or more track samples, and one track sample is configured to encapsulate code stream data corresponding to one dynamic media frame. The computer device may add an object information data box j corresponding to the media track j in the P media tracks to a track sample entry of the media track j. Each media track may correspond to one object information data box, and an object property feature of a media object in a media frame belonging to a corresponding media track is encapsulated in the object information data box. The object information data box j may be located in the track sample entry of the media track j or a track sample entry of a metadata track corresponding to the media track j. The computer device may acquire the object property feature of the media object in the dynamic media frame belonging to the media track j from the object information data box j corresponding to the media track j. Further, the computer device may determine the target media track satisfying the decoding condition from the P media tracks according to the object property features corresponding to the P media tracks respectively. In this way, the media track satisfying the decoding condition can be rapidly located from the P media tracks according to the object property feature, encapsulated in the object information data box, of the media object in the corresponding media track. Thus, efficiency of acquiring the media data can be improved.

Further, the object indication information further includes an object property feature and a distribution feature of a media object in a media frame belonging to each media track, the object property feature and the distribution feature of the media object in the media frame belonging to each media track being encapsulated in a metadata track associated with a corresponding media track. With the media track j as an example, the object property feature and the distribution feature of the media object in the media frame belonging to the media track j are encapsulated in the metadata track associated with the media track j. The metadata track includes a track sample entry and one or more track samples, one track sample in the metadata track being configured to encapsulate an object property feature and a distribution feature of a media object in one media frame. The track samples in the media track j correspond one-to-one to track samples in the metadata track associated with the media track j. The computer device may acquire the object indication information corresponding to the dynamic media frame belonging to the target media track from the metadata track corresponding to the target media track, and determine the to-be-decoded media file segment according to the object indication information corresponding to the dynamic media frame belonging to the target media track. The object indication information of the dynamic media frame belonging to the target media track is encapsulated in the metadata track corresponding to the target media track.

In an embodiment, the metadata track corresponding to the media track may include a synchronous track sample and a non-synchronous track sample. The synchronous track sample encapsulates an object property feature and a distribution feature of a media object in a media frame belonging to a corresponding media track. The non-synchronous track sample encapsulates an object change feature and a distribution change feature between the media frame belonging to the corresponding media track and a reference media frame. The object change feature is a change feature between the object property feature of the media object in the media frame belonging to the corresponding media track and an object property feature of a media object in the reference media frame. The distribution change feature is a change feature between the distribution feature of the media object in the media frame belonging to the corresponding media track and a distribution feature of the media object in the reference media frame. With acquisition of the object indication information corresponding to the dynamic media frame a belonging to the media track j as an example, the computer device may determine a track sample corresponding to the dynamic media frame a from track samples of the metadata track corresponding to the media track j as a target track sample. When the target track sample encapsulates the object property feature and the distribution feature of the media object included in the dynamic media frame a, the object indication information stored in the target track sample is directly taken as the object indication information corresponding to the dynamic media frame a. When the target track sample encapsulates the object change feature and the distribution change feature corresponding to the media object included in the dynamic media frame a, the computer device may acquire the reference media frame corresponding to the dynamic media frame a and the object property feature and the distribution feature of the media object in the reference media frame. Further, the computer device may determine the object indication information corresponding to the dynamic media frame a according to the object property feature and the distribution feature of the media object in the reference media frame and the object change feature and the distribution change feature stored in the target track sample. In this way, only the change feature is stored in the non-synchronous track sample. Thus, repeated storage can be avoided, a number of to-be-stored data can be decreased, and storage pressure can be reduced.

In an embodiment, the operation that the computer device determines the to-be-decoded media file segment according to the object indication information corresponding to the dynamic media frame belonging to the target media track may include the following operations: The target dynamic media frame satisfying the decoding condition is determined from the dynamic media frames belonging to the target media track according to the object indication information corresponding to the dynamic media frames belonging to the target media track. The to-be-decoded media file segment is determined according to code stream data related to the target dynamic media frame in the target media track and the object indication information of the target dynamic media frame.

In some examples, the computer device may determine the target dynamic media frame satisfying the decoding condition from the dynamic media frames belonging to the target media track according to the object indication information corresponding to the dynamic media frames belonging to the target media track. For example, a dynamic media frame including the target media object or a dynamic media frame including no target media object is acquired. Further, the object indication information corresponding to the dynamic media frame may be the object property feature. The object property feature may be an object identifier and object description information. The target dynamic media frame may be determined from the dynamic media frames belonging to the target media track according to the object property features of the dynamic media frames belonging to the target media track. Further, the computer device may determine the to-be-decoded media file segment according to code stream data related to the target dynamic media frame in the target media track and the object indication information of the target dynamic media frame. It can be seen that the target media frame can be rapidly located through the object property feature of the media object included in each media frame, and efficiency of acquiring the media data can be improved.

In an embodiment, the operation that the computer device determines the to-be-decoded media file segment according to code stream data related to the target dynamic media frame in the target media track and the object indication information of the target dynamic media frame may include the following operations: A slice satisfying the decoding condition is determined from the target dynamic media frame as a first slice according to the object indication information of the target dynamic media frame. Code stream data related to the first slice in the code stream data corresponding to the target dynamic media frame are determined as the to-be-decoded media file segment.

In some examples, the object indication information of the target dynamic media frame may include a distribution feature of the media object in the target dynamic media frame, for example, a spatial region to which the media object belongs in the target dynamic media frame and a slice (such as a point cloud slice or video slice) to which the media object belongs in the target dynamic media frame, one spatial region corresponding to one slice. The computer device may determine the slice satisfying the decoding condition from the target dynamic media frame as the first slice according to the spatial region to which the media object belongs in the target dynamic media frame and the slice to which the media object belongs in the target dynamic media frame. The code stream data corresponding to the target dynamic media frame include the code stream data of the first slice. The computer device may determine the code stream data related to the first slice in the code stream data corresponding to the target dynamic media frame as the to-be-decoded media file segment. It can be seen that the code stream data corresponding to the slice satisfying the decoding condition can be rapidly located through the distribution feature of the media object in the media frame. Only the code stream data corresponding to the slice needs to be decoded. Thus, a number of to-be-decoded data can be decreased, and efficiency of acquiring the media data can be improved.

In an embodiment, the encapsulated media file includes Q media items corresponding to Q static media frames in the N media frames, and the object indication information includes object indication information corresponding to the Q media items respectively, Q being a positive integer less than or equal to N. The operation that the computer device acquires a to-be-decoded media file segment from the encapsulated media file corresponding to the N media frames according to the object indication information may include the following operations: A target media item satisfying the decoding condition is determined from the Q media items according to the object indication information corresponding to the Q media items respectively. The to-be-decoded media file segment is determined according to the target media item and the object indication information corresponding to the target media item.

In some examples, the media items are obtained by encapsulating code stream data corresponding to the static media frames. The object indication information corresponding to each media item may include an object property feature and a distribution feature of a media object included in a static media frame associated with the corresponding media item. The computer device may determine the target media item satisfying the decoding condition from the Q media items according to the object indication information corresponding to the Q media items respectively. In some examples, the object indication information may include the object property feature of the media object. The object property feature may include an object number, an object identifier, and object description information. The computer device may determine the target media item satisfying the decoding condition from the Q media items according to the object property features corresponding to the Q media items respectively. For example, a target media item including the target media object or a target media item including no target media object is determined. Further, the computer device may determine the to-be-decoded media file segment according to the target media item and the object indication information corresponding to the target media item. It can be seen that the target media item can be rapidly located through the object indication information corresponding to the media item. Thus, efficiency of acquiring the media data can be improved.

In an embodiment, the operation that the computer device determines the to-be-decoded media file segment according to the target media item and the object indication information corresponding to the target media item may include the following operations: A point cloud slice satisfying the decoding condition is determined from a static media frame corresponding to the target media item as a second point cloud slice according to the object indication information corresponding to the target media item. Code stream data corresponding to the second point cloud slice are determined from the target media item as the to-be-decoded media file segment.

In some examples, the object indication information corresponding to the target media item may include a distribution feature of the media object included in the static media frame corresponding to the target media item in the corresponding static media frame, for example, a spatial region to which the media object belongs in the corresponding static media frame, or a slice (such as a point cloud slice or video slice) to which the media object belongs in the corresponding static media frame, one spatial region corresponding to one slice. The computer device may determine a slice satisfying the decoding condition from the static media frame corresponding to the target media item as the second slice according to the spatial region to which the media object belongs in the corresponding static media frame and the slice to which the media object belongs in the corresponding static media frame. The target media item includes code stream data of the second slice. The computer device may determine the code stream data related to the second slice in the code stream data corresponding to the target media item as the to-be-decoded media file segment. It can be seen that the code stream data corresponding to the slice satisfying the decoding condition can be rapidly located through the distribution feature of the media object in the media frame, and only the code stream data corresponding to the slice needs to be decoded. Thus, a number of to-be-decoded data can be decreased, and efficiency of acquiring the media data can be improved.

In an embodiment, the encapsulated media file includes a first media file and a second media file, and the object indication information includes object indication information of the first media file, object indication information of the second media file, and object relation indication information. The object relation indication information is configured for indicating that a media object in a media frame corresponding to the first media file has an association relation with a media object in a media frame corresponding to the second media file. The object indication information of the first media file is encapsulated in the first media file, and the object indication information of the second media file is encapsulated in the second media file. The operation that the computer device acquires a to-be-decoded media file segment from the encapsulated media file corresponding to the N media frames according to the object indication information may include the following operations: The second media file having an association relation with the first media file is acquired according to the object relation indication information when it is determined that the first media file satisfies the decoding condition. The to-be-decoded media file segment is determined according to the first media file and the second media file.

In some examples, the object indication information further includes object relation indication information, and the object relation indication information is configured for indicating a plurality of media files including media objects having the association relation. For example, if media frames corresponding to a plurality of media file segments in the encapsulated media file respectively include identical media objects, the object relation indication information may be configured for indicating that the plurality of media files including the identical media objects have an association relation. In some examples, with the encapsulated media file including the first media file and the second media file as an example, when the media object in the media frame corresponding to the first media file has the association relation with the media object in the media frame corresponding to the second media file, the object relation indication information is configured for indicating that the media object in the media frame corresponding to the first media file has the association relation with the media object in the media frame corresponding to the second media file.

In some examples, when determining that the first media file satisfying the decoding condition, the computer device acquires the second media file having the association relation with the first media file according to the object relation indication information. The computer device may determine the to-be-decoded media file segment from the first media file and the second media file according to the object indication information corresponding to the first media file and the object indication information corresponding to the second media file. For example, the to-be-decoded media file segment indicates media file segments of the target media objects included in the first media file and the second media file, or media file segments of associated media objects (such as a plurality of media objects having a binding relation) included in the first media file and the second media file. It can be seen that different media files having the association relation can be rapidly acquired through the object relation indication information. Thus, joint demonstration or associated demonstration of different media files having the association relation can be achieved.

S203, decode the to-be-decoded media file segment, so as to obtain media data corresponding to the to-be-decoded media file segment.

In some examples, the computer device only needs to decode the to-be-decoded media file segment, so as to obtain the media data corresponding to the to-be-decoded media file segment, and may demonstrate the media data corresponding to the to-be-decoded media file segment. The media data corresponding to the to-be-decoded media file segment may be media frame data including the target media object. Interaction with the target media object is supported based on demonstration of the media data of the target media object. The media data corresponding to the to-be-decoded media file segment may be slices data including the target media object. Only the slices data need to be decoded and demonstrated. Thus, resource (such as computing resource) overhead of the decoding device can be reduced. The media data corresponding to the to-be-decoded media file segment may be the plurality of media files (such as media tracks or media items) having the association relation, and joint demonstration or associated demonstration of different media files may be achieved. It can be seen that the required media data can be rapidly acquired from the encapsulated media file through the object indication information. Thus, efficiency of acquiring the media data can be improved.

In the embodiment of this disclosure, the decoding device may receive the object indication information transmitted by the encoding device. The object indication information is configured for reflecting the object property features of the media objects included in the N media frames and the distribution features of the media objects in the N media frames. To be specific, the object indication information is configured for reflecting types of the media objects included in the N media frames, the media frames including the media objects, positions for including the media objects of the media frames, etc. The decoding device can rapidly acquire the required media frame (i.e. media data) based on the object indication information. Thus, the to-be-decoded media file segment can be rapidly acquired from the encapsulated media file corresponding to the N media frames according to the object indication information. The to-be-decoded media file segment can be a media file segment corresponding to the media data required by the decoding device. Thus, efficiency of acquiring the to-be-decoded media file segment can be improved. Further, the media data (such as the media data required by the decoding device) corresponding to the to-be-decoded media file segment can be obtained by decoding only the to-be-decoded media file segment, instead of decoding an entire media file. Thus, a number of to-be-decoded data can be decreased, efficiency of acquiring the media data can be improved, and resource (such as computing resource) overhead of the decoding device can be reduced.

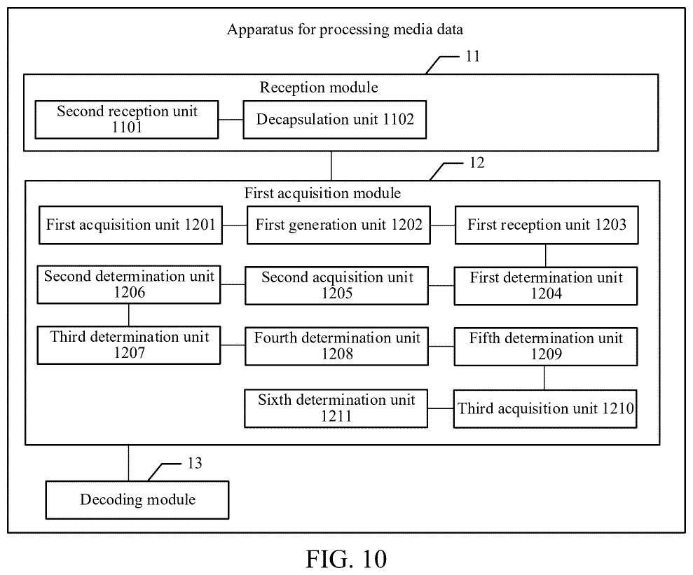

With reference to FIG. 10, a schematic structural diagram of an apparatus for processing media data according to an embodiment of this disclosure is shown. As shown in FIG. 10, the apparatus for processing media data may include: a reception module 11, a first acquisition module 12, and a decoding module 13.

The reception module 11 is configured to receive object indication information, the object indication information being configured for reflecting object property features of media objects included in N media frames and distribution features of the media objects in the N media frames, and N being a positive integer.

The first acquisition module 12 is configured to acquire a to-be-decoded media file segment from an encapsulated media file corresponding to the N media frames according to the object indication information.

The decoding module 13 is configured to decode the to-be-decoded media file segment, so as to obtain media data corresponding to the to-be-decoded media file segment.

The object property feature includes one or more of an object number, an object identifier, and object description information of the media object included in each of the N media frames.

The distribution feature is configured for indicating a target media frame having the media object in the N media frames; alternatively,
the distribution feature is configured for indicating a target media frame having the media object in the N media frames and a spatial region to which the media object belongs in the target media frame; alternatively,
the distribution feature is configured for indicating a target media frame having the media object in the N media frames and a slice to which the media object belongs in the target media frame; and alternatively,
the distribution feature is configured for indicating a target media frame having the media object in the N media frames, a spatial region to which the media object belongs in the target media frame, and a slice to which the media object belongs in the target media frame.

The to-be-decoded media file segment is code stream data including a target media object. Alternatively, the to-be-decoded media file segment is code stream data including no target media object. The target media object belongs to the media objects in the N media frames.

The object indication information includes object indication information associated with S media file segments respectively. The S media file segments belong to the encapsulated media file.

The first acquisition module 12 includes:
a first acquisition unit 1201 configured to acquire segment identifiers corresponding to the S media file segments respectively;
a first generation unit 1202 configured to generate, if object indication information of a target media file segment in the S media file segments reflects that the target media file segment satisfies a decoding condition, an acquisition request for the target media file segment according to a segment identifier of the target media file segment;
a first reception unit 1203 configured to transmit the acquisition request to an encoding device and receive the target media file segment returned by the encoding device based on the acquisition request; and
a first determination unit 1204 configured to determine the target media file segment as a to-be-decoded media file segment.

The reception module 11 includes:
a second reception unit 1101 configured to receive a target media file transmitted by the encoding device;
a decapsulation unit 1102 configured to decapsulate the target media file, so as to obtain the object indication information related to the N media frames,
the encapsulated media file including P media tracks to which K dynamic media frames in the N media frames belong, P being a positive integer, and K being a positive integer less than or equal to N.

The first acquisition module 12 includes:
a second acquisition unit 1205 configured to acquire, from an object information data box j corresponding to a media track j, an object property feature of a media object in a dynamic media frame belonging to the media track j, j being a positive integer less than or equal to P;
a second determination unit 1206 configured to determine a target media track satisfying a decoding condition from the P media tracks according to object property features corresponding to the P media tracks respectively; and
a third determination unit 1207 configured to determine the to-be-decoded media file segment according to object indication information corresponding to a dynamic media frame belonging to the target media track, the object indication information of the dynamic media frame belonging to the target media track being encapsulated in a metadata track corresponding to the target media track.

The third determination unit 1207 is configured to:
determine a target dynamic media frame satisfying the decoding condition from the dynamic media frames belonging to the target media track according to object indication information corresponding to the dynamic media frame belonging to the target media track; and
determine the to-be-decoded media file segment according to code stream data related to the target dynamic media frame in the target media track and the object indication information of the target dynamic media frame.

The operation of determination of the to-be-decoded media file segment according to code stream data related to the target dynamic media frame in the target media track and the object indication information of the target dynamic media frame includes the following operations:

A slice satisfying the decoding condition is determined from the target dynamic media frame as a first slice according to the object indication information of the target dynamic media frame.

Code stream data related to the first slice in the code stream data corresponding to the target dynamic media frame are determined as the to-be-decoded media file segment.

The encapsulated media file includes Q media items corresponding to Q static media frames in the N media frames, and the object indication information includes object indication information corresponding to the Q media items respectively, Q being a positive integer less than or equal to N.

The first acquisition module 12 includes:
a fourth determination unit 1208 configured to determine a target media item satisfying the decoding condition from the Q media items according to the object indication information corresponding to the Q media items respectively; and
a fifth determination unit 1209 configured to determine the to-be-decoded media file segment according to the target media item and object indication information corresponding to the target media item.

The fifth determination unit 1209 is configured to:
determine a point cloud slice satisfying the decoding condition from a static media frame corresponding to the target media item as a second point cloud slice according to the object indication information corresponding to the target media item; and
determine code stream data corresponding to the second point cloud slice from the target media item as the to-be-decoded media file segment.

The encapsulated media file related to the N media frames includes a first media file and a second media file, and the object indication information includes object indication information of the first media file, object indication information of the second media file, and object relation indication information. The object relation indication information is configured for indicating that a media object in a media frame corresponding to the first media file has an association relation with a media object in a media frame corresponding to the second media file, the object indication information of the first media file is encapsulated in the first media file, and the object indication information of the second media file is encapsulated in the second media file.

The first acquisition module 12 includes:
a third acquisition unit 1210 configured to acquire the second media file having the association relation with the first media file according to the object relation indication information when it is determined that the first media file satisfies the decoding condition; and
a sixth determination unit 1211 configured to determine the to-be-decoded media file segment according to the first media file and the second media file.

In the embodiment of this disclosure, after acquiring the encapsulated media file corresponding to the N media frames, the encoding device may generate, when the N media files include the media objects, the object indication information related to the N media frames. The object indication information is configured for reflecting the object property features of the media objects included in the N media frames and the distribution features of the media objects in the N media frames. To be specific, the object indication information is configured for reflecting types of the media objects included in the N media frames, the media frames including the media objects, positions for including the media objects of the media frames, etc. The media frame (i.e. the media data) required by the decoding device can be rapidly acquired from the encapsulated media file based on the object indication information. The object indication information and the encapsulated media file are transmitted to the decoding device. The decoding device can rapidly acquire the to-be-decoded media file segment from the encapsulated media file corresponding to the N media frames according to the object indication information. The to-be-decoded media file segment can be a media file segment corresponding to the media data required by the decoding device. Thus, efficiency of acquiring the to-be-decoded media file segment can be improved. Further, the media data (such as the media data required by the decoding device) corresponding to the to-be-decoded media file segment can be obtained by decoding only the to-be-decoded media file segment, instead of decoding an entire media file. Thus, a number of to-be-decoded data can be decreased, efficiency of acquiring the media data can be improved, and resource (such as computing resource) overhead of the decoding device can be reduced.

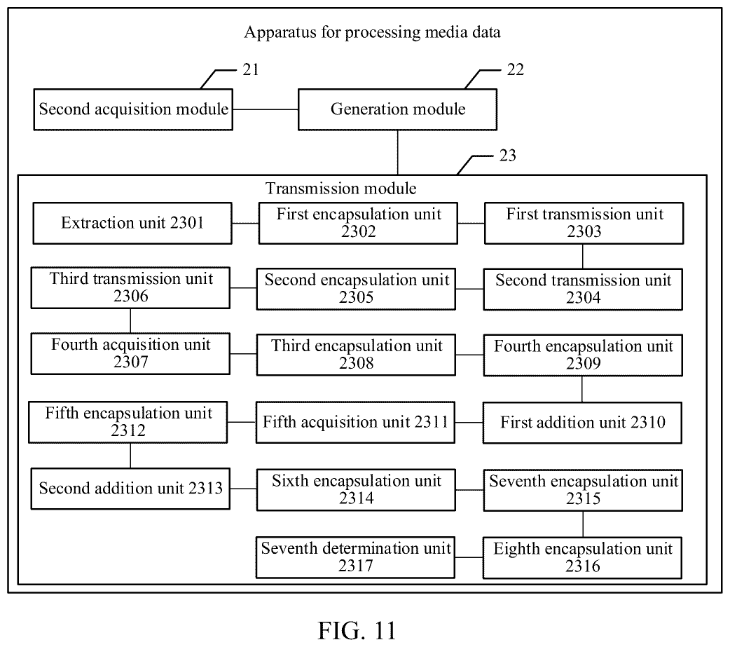

With reference to FIG. 11, a schematic structural diagram of an apparatus for processing media data according to an embodiment of this disclosure is shown. As shown in FIG. 11, the apparatus for processing media data may include: a second acquisition module 21, a generation module 22, and a transmission module 23.

The second acquisition module 21 is configured to acquire an encapsulated media file related to N media frames, N being a positive integer.

The generation module 22 is configured to generate, if the N media frames include media objects, object indication information related to the N media frames. The object indication information being configured for indicating object property features corresponding to the media objects included in the N media frames and distribution features of the media objects in the N media frames.

The transmission module 23 is configured to transmit the encapsulated media file and the object indication information to the decoding device.

The transmission module 23 includes:
an extraction unit 2301 configured to extract, if the encapsulated media file includes S media file segments, object indication information associated with the S media file segments respectively from the object indication information, S being an integer greater than 1;
a first encapsulation unit 2302 configured to encapsulate object indication information associated with a media file segment i in the S media file segments in the media file segment i, so as to obtain a target media file segment i, S being an integer greater than 1, and i being a positive integer less than or equal to S;
a first transmission unit 2303 configured to transmit the object indication information associated with the S media file segments respectively and segment identifiers corresponding to the S media file segments respectively to the decoding device; and
a second transmission unit 2304 configured to transmit, if an acquisition request for the target media file segment i is received, the target media file segment i to the decoding device, the acquisition request being generated by the decoding device based on the object indication information and the segment identifiers associated with the S media file segments respectively.

The transmission module 23 includes:
a second encapsulation unit 2305 configured to encapsulate the object indication information in the encapsulated media file, so as to obtain the target media file; and
a third transmission unit 2306 configured to transmit the target media file to the decoding device.

The N media frames include K dynamic media frames including the media objects, and the encapsulated media file includes P media tracks to which the K dynamic media frames belong, P being a positive integer, and K being a positive integer less than or equal to N.

The transmission module 23 includes:
a fourth acquisition unit 2307 configured to acquire an object property feature and a distribution feature of a media object included in a dynamic media frame belonging to a media track j from the object indication information, j being a positive integer less than or equal to P;
a third encapsulation unit 2308 configured to encapsulate the object property feature of the media object in the dynamic media frame belonging to the media track j in an object information data box j associated with the media track j;
a fourth encapsulation unit 2309 configured to encapsulate the object property feature and the distribution feature of the media object included in the dynamic media frame belonging to the media track j in a metadata track corresponding to the media track j; and
a first addition unit 2310 configured to add object information data boxes and metadata tracks corresponding to the P media tracks respectively to the encapsulated media file, so as to obtain the target media file, and transmit the target media file to the decoding device.

The metadata track corresponding to the media track j includes metadata track samples corresponding to the dynamic media frames belonging to the media track j respectively.

The fourth encapsulation unit 2309 is configured to:
add an object property feature and a distribution feature of a media object included in a dynamic media frame a belonging to the media track j to a metadata track sample corresponding to the dynamic media frame a, a being a positive integer less than or equal to a total number of the dynamic media frames belonging to the media track j.

The metadata track corresponding to the media track j includes metadata track samples corresponding to the dynamic media frames belonging to the media track j respectively.

The fourth encapsulation unit 2309 is configured to:
acquire an object property feature and a distribution feature of a media object in a reference media frame corresponding to a dynamic media frame a belonging to a media track j, a being a positive integer less than or equal to the total number of the dynamic media frames belonging to the media track j;
determine an object change feature between the object property feature of the media object in the reference media frame and an object property feature of the dynamic media frame a;
determine a distribution change feature between the distribution feature of the media object in the reference media frame and a distribution feature of the dynamic media frame a; and
add the object change feature and the distribution change feature to a metadata track sample corresponding to the dynamic media frame a.

The first addition unit 2310 is configured to:
add the object information data box j to a track sample entry of the media track j; and
add the metadata tracks corresponding to the P media tracks respectively to the encapsulated media file, so as to obtain the target media file.

The first addition unit 2310 is configured to:
add the object information data box j to a track sample entry of a metadata track corresponding to the media track j, so as to obtain an added metadata track corresponding to the media track j; and
add added metadata tracks corresponding to the P media tracks respectively to the encapsulated media file, so as to obtain the target media file.

The N media frames include Q static media frames including the media objects, and the encapsulated media file includes Q media items corresponding to the Q static media frames, Q being a positive integer less than or equal to N.

The transmission module 23 includes:
a fifth acquisition unit 2311 configured to acquire an object property feature and a distribution feature of a media object in a static media frame corresponding to a media item r from the object indication information, r being a positive integer less than or equal to Q;
a fifth encapsulation unit 2312 configured to encapsulate an object property feature and a distribution feature of a media object in a static media frame corresponding to a media item r in an item property box associated with the media item r; and
a second addition unit 2313 configured to add item property boxes corresponding to the Q media items respectively to the encapsulated media file, so as to obtain a target media file, and transmit the target media file to the decoding device.

The encapsulated media file related to the N media frames includes a first media file and a second media file.

The object indication information includes object relation indication information. The object relation indication information is configured for indicating that a media object in a media frame corresponding to the first media file has an association relation with a media object in a media frame corresponding to the second media file.

The transmission module 23 includes:
a sixth encapsulation unit 2314 configured to encapsulate the object relation indication information in an associated entity group box;
a seventh encapsulation unit 2315 configured to encapsulate an object property feature and an object distribution feature of the media object in the media frame corresponding to the first media file in the first media file;
an eighth encapsulation unit 2316 configured to encapsulate an object property feature and an object distribution feature of the media object in the media frame corresponding to the second media file in the second media file; and
a seventh determination unit 2317 configured to determine the associated entity group box, the encapsulated first media file, and the encapsulated second media file as the target media file, and transmit the target media file to the decoding device.

In the embodiment of this disclosure, the decoding device may receive the object indication information transmitted by the encoding device. The object indication information is configured for reflecting the object property features of the media objects included in the N media frames and the distribution features of the media objects in the N media frames. To be specific, the object indication information is configured for reflecting types of the media objects included in the N media frames, the media frames including the media objects, positions for including the media objects of the media frames, etc. The decoding device can rapidly acquire the required media frame (i.e. media data) based on the object indication information. Thus, the to-be-decoded media file segment can be rapidly acquired from the encapsulated media file corresponding to the N media frames according to the object indication information. The to-be-decoded media file segment can be a media file segment corresponding to the media data required by the decoding device. Thus, efficiency of acquiring the to-be-decoded media file segment can be improved. Further, the media data (such as the media data required by the decoding device) corresponding to the to-be-decoded media file segment can be obtained by decoding only the to-be-decoded media file segment, instead of decoding an entire media file. Thus, a number of to-be-decoded data can be decreased, efficiency of acquiring the media data can be improved, and resource (such as computing resource) overhead of the decoding device can be reduced.

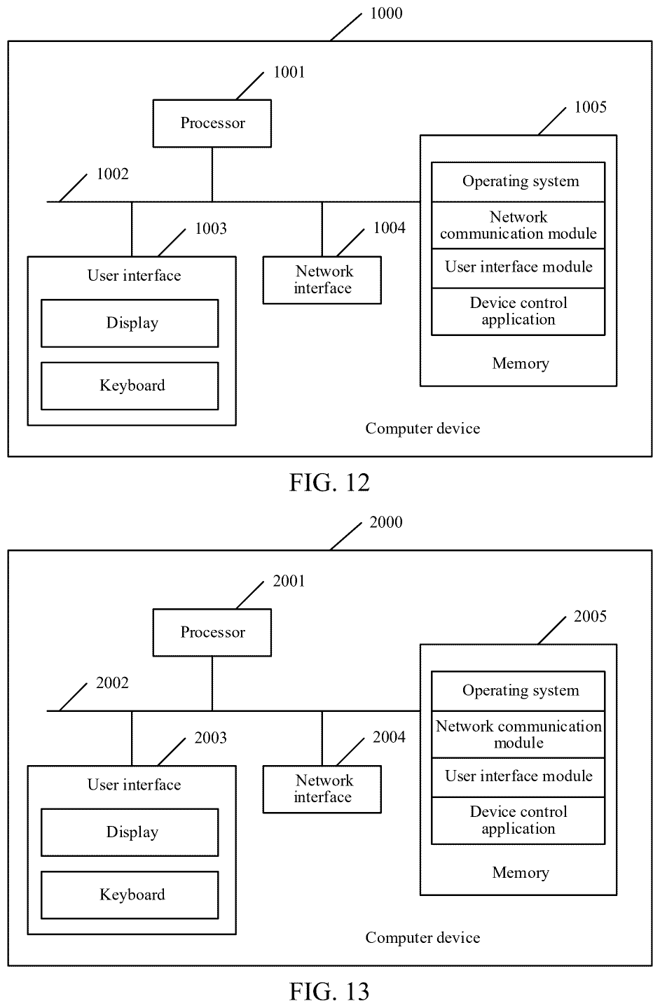

With reference to FIG. 12, a schematic structural diagram of a computer device according to an embodiment of this disclosure is shown. As shown in FIG. 12, the computer device 1000 may include: a processor 1001, a network interface 1004, and a memory 1005. In addition, the above computer device 1000 may further include: a user interface 1003 and at least one communication bus 1002. The communications bus 1002 is configured to implement connection communication between these components. The user interface 1003 may include a display and a keyboard. In an embodiment, the user interface 1003 may further include a standard wired interface and a standard wireless interface. In an embodiment, the network interface 1004 may include a standard wired interface and a standard wireless interface (such as a wireless fidelity (Wi-Fi) interface). The memory 1005 may be a high-speed random access memory (RAM) or a non-volatile memory, such as at least one magnetic disk memory. In an embodiment, the memory 1005 or may be at least one storage apparatus that is located away from the foregoing processor 1001. As shown in FIG. 12, the memory 1005, as a type of computer-readable storage medium, may include an operating system, a network communication module, a user interface module, and a device control application.

In the computer device 1000 shown in FIG. 12, the network interface 1004 may provide a network communication function. The user interface 1003 is mainly configured to provide an input interface for a user. The processor 1001 may be configured to invoke the device control application stored in the memory 1005, so as to:
acquire an encapsulated media file related to N media frames, N being a positive integer;
generate, if the N media frames include media objects, object indication information related to the N media frames, the object indication information being configured for indicating object property features corresponding to the media objects included in the N media frames and distribution features of the media objects in the N media frames; and
transmit the encapsulated media file and the object indication information to a decoding device.

In the embodiment of this disclosure, the computer device 1000 may perform the description of the method for processing media data in the embodiment corresponding to FIG. 2 or the description of the apparatus for processing media data in the embodiment corresponding to FIG. 10, which will not be repeated herein. Also, the beneficial effects obtained through the same method will not be described in detail herein.

With reference to FIG. 13, a schematic structural diagram of a computer device according to an embodiment of this disclosure is shown. As shown in FIG. 13, the computer device 2000 may include: a processor 2001, a network interface 2004, and a memory 2005. In addition, the above computer device 2000 may further include: a user interface 2003 and at least one communication bus 2002. The communications bus 2002 is configured to implement connection communication between these components. The user interface 2003 may include a display and a keyboard. In an embodiment, the user interface 2003 may further include a standard wired interface and a standard wireless interface. In an embodiment, the network interface 2004 may include a standard wired interface and a standard wireless interface (such as a Wi-Fi interface). The memory 2005 may be a high-speed RAM or a non-volatile memory, such as at least one magnetic disk memory. In an embodiment, the memory 2005 or may be at least one storage apparatus that is located away from the foregoing processor 2001. As shown in FIG. 13, the memory 2005, as a type of computer-readable storage medium, may include an operating system, a network communication module, a user interface module, and a device control application.

In the computer device 2000 shown in FIG. 13, the network interface 2004 may provide a network communication function. The user interface 2003 is mainly configured to provide an input interface for a user. The processor 2001 may be configured to invoke the device control application stored in the memory 2005, so as to:
receive object indication information, the object indication information being configured for reflecting object property features of media objects included in N media frames and distribution features of the media objects in the N media frames, and N being a positive integer;
acquire a to-be-decoded media file segment from an encapsulated media file corresponding to the N media frames according to the object indication information; and
decode the to-be-decoded media file segment, so as to obtain media data corresponding to the to-be-decoded media file segment.

In the embodiment of this disclosure, the computer device 2000 may perform the description of the method for processing media data in the embodiment corresponding to FIG. 9 or the description of the apparatus for processing media data in the embodiment corresponding to FIG. 11, which will not be repeated herein. Also, the beneficial effects obtained through the same method will not be described in detail herein.

In addition, a computer-readable storage medium is further provided in the embodiments of this disclosure. The above computer-readable storage medium has a computer program executed by the apparatus for processing media data stored therein, the computer program including program instructions. The processor, when executing the program instructions, may perform the description of the method for processing media data in the corresponding embodiment, which will not be repeated herein. Also, the beneficial effects obtained through the same method will not be described in detail herein. Reference can be made to the description of the method embodiment of this disclosure for technical details not disclosed in the embodiment of the computer-readable storage medium involved in this disclosure.

As an example, the program instructions may be deployed in one computer device for execution, deployed in at least two computer devices at one position for execution, or executed in at least two computer devices distributed at least two position and interconnected via a communication network. The at least two computer devices distributed at least two positions and interconnected via the communication network may form a blockchain network.

The computer-readable storage medium may be the apparatus for processing media data according to any one of the foregoing embodiments or an internal storage unit of the computer device, such as a hard disk or an internal memory of the computer device. The computer-readable storage medium or may be an external storage device of the computer device, such as a plug-in hard disk, a smart media card (SMC), a secure digital (SD) card, and a flash card configured in the computer device. Further, the computer-readable storage medium may further include the internal storage unit and the external storage device of the computer device. The computer-readable storage medium is configured to store the computer program and other programs and data that are required by the computer device. The computer-readable storage medium may be further configured to temporarily store data that have been outputted or are to be outputted.

The terms “first”, “second”, etc. in the description in the embodiments, claims, and accompanying drawings of this disclosure are used for distinguishing between different media contents, and are not used for describing a particular sequence. In addition, the terms “comprise”, “include”, and their any variations are intended to cover the non-exclusive inclusion. For example, a process, method, apparatus, product, or device including a series of steps or units is not limited to steps or modules listed, but further exemplarily includes steps or modules not listed, or further exemplarily includes other steps or units inherent to the process, method, apparatus, product, or device.

In the above embodiments of this disclosure, if user information needs to be used, it is necessary to obtain user permission or consent and comply with relevant laws and regulations of relevant regions.

A computer program product is further provided in the embodiments of this disclosure. The computer program product includes a computer program/instructions, the computer program/instructions, when executed by a processor, implementing the description of the method for processing media data in the corresponding embodiment, which will not be repeated herein. Also, the beneficial effects obtained through the same method will not be described in detail herein. Reference can be made to the description of the method embodiment of this disclosure for technical details not disclosed in the embodiment of the computer program product involved in this disclosure.

Those of ordinary skill in the art can realize that the units and algorithm steps in each example described in combination with the embodiments disclosed herein can be implemented through electronic hardware, computer software, or their combination. To clearly describe the interchangeability between the hardware and the software, compositions and steps in each example have been generally described based on functions in the above descriptions. Whether the functions are executed in a mode of hardware or software depends on particular disclosures and design constraint conditions of the technical solutions. Those skilled in the art can implement the described functions through different methods for each particular disclosure, but such an implementation is not to be deemed as falling beyond the scope of this disclosure.

The methods and related apparatuses according to the embodiments of this disclosure are described with reference to the method flowcharts and/or schematic structural diagrams according to the embodiments of this disclosure. In some examples, each flow in the method flowcharts and/or each block in the schematic structural diagrams and combinations of flows in the flowcharts and/or blocks in the block diagrams can be implemented through computer program instructions. These computer program instructions can be provided for a processor of a general-purpose computer, a special-purpose computer, an embedded processing machine, or another programmable network connection device to generate a machine. Thus, instructions executed by the processor of the computer or another programmable network connection device generate an apparatus configured to implement functions specified in one or more flows in the flowcharts and/or one or more blocks in the schematic structural diagrams. These computer program instructions or can be stored in a computer-readable memory that can direct the computer or another programmable network connection device to operate in a particular way. Thus, the instructions stored in the computer-readable memory generate a product including an instruction apparatus. The instruction apparatus implements the functions specified in one or more flows in the flowcharts and/or one or more blocks in the schematic structural diagrams. These computer program instructions or can be loaded onto the computer or another programmable network connection device, so that a series of operation steps are executed in the computer or another programmable device, so as to generate computer-implementable processing. Thus, the instructions executed in the computer or another programmable device provide steps for implementing the functions specified in one or more flows in the flowcharts and/or one or more blocks in the schematic structural diagrams.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

What are disclosed above are merely exemplary embodiments of this disclosure, and certainly are not intended to limit the scope of claims of this disclosure. Thus, equivalent variations made according to the claims of this disclosure still fall within the scope of this disclosure.

What is claimed is:

1. A method for processing media data, comprising:
receiving object indication information associated with N media frames, the object indication information being indicative of respective object property features of media objects in the N media frames and respective distribution features of the media objects in the N media frames, and N being a positive integer;
acquiring, according to the object indication information associated with the N media frames, a to-be-decoded media file segment from an encapsulated media file, the N media frames being encapsulated in the encapsulated media file; and
decoding the to-be-decoded media file segment to obtain media data from the to-be-decoded media file segment.

2. The method according to claim 1, wherein an object property feature of a media object comprises one or more of an object number of the media object in the N media frames, an object identifier of the media object, and object description information of the media object.

3. The method according to claim 1, wherein:
a distribution feature of a media object is indicative one of:
a target media frame in the N media frames, the target media frame having the media object;
the target media frame in the N media frames and a spatial region of the target media frame that includes the media object;
the target media frame in the N media frames and a slice of the target media frame that includes the media object; and
the target media frame in the N media frames, the spatial region of the target media frame that includes the media object, and the slice of the target media frame that includes the media object.

4. The method according to claim 1, wherein the to-be-decoded media file segment is one of:
a first code stream data comprising a target media object; or
a second code stream data comprising no target media object, the target media object being one of the media objects in the N media frames.

5. The method according to claim 1, wherein:
the object indication information comprises respective first object indication information associated with S media file segments of the encapsulated media file, S being an integer greater than 1; and
the acquiring the to-be-decoded media file segment comprises:
acquiring respective segment identifiers of the S media file segments,
generating, when first object indication information associated with a target media file segment in the S media file segments indicates that the target media file segment satisfies a decoding condition, an acquisition request for the target media file segment according to a first segment identifier of the target media file segment,
transmitting the acquisition request to an encoding device, and
receiving the target media file segment that is returned by the encoding device based on the acquisition request, the target media file segment being the to-be-decoded media file segment.

6. The method according to claim 1, wherein:
the encapsulated media file comprises P media tracks that include K dynamic media frames in the N media frames, P being a positive integer, and K being a positive integer less than or equal to N; and
the acquiring the to-be-decoded media file segment comprises:
acquiring respective first object property features associated with the P media tracks, a first object property feature associated with a media track j being acquired from an object information data box j of the media track j and including at least an object property feature of a media object in one or more dynamic media frames in the media track j, j being a positive integer less than or equal to P,
determining a target media track from the P media tracks according to the respective first object property features associated with the P media tracks, the target media track satisfying a decoding condition,
determining the to-be-decoded media file segment according to a portion of the object indication information of first one or more dynamic media frames in the target media track, and
encapsulating the portion of the object indication information of the first one or more dynamic media frames in the target media track in a metadata track of the target media track.

7. The method according to claim 6, wherein the determining the to-be-decoded media file segment comprises:
determining, from the first one or more dynamic media frames of the target media track, a target dynamic media frame that satisfies the decoding condition according to the portion of the object indication information of the first one or more dynamic media frames; and
determining the to-be-decoded media file segment according to code stream data of the target dynamic media frame in the target media track and object indication information of the target dynamic media frame in the object indication information associated with the N media frames.

8. The method according to claim 7, wherein the determining the to-be-decoded media file segment according to the code stream data of the target dynamic media frame comprises:
determining a first slice from the target dynamic media frame according to the object indication information of the target dynamic media frame, the first slice satisfying the decoding condition; and
determining first code stream data of the first slice in the code stream data of the target dynamic media frame as the to-be-decoded media file segment.

9. The method according to claim 1, wherein:
the encapsulated media file comprises Q media items corresponding to Q static media frames in the N media frames;
the object indication information associated with the N media frames comprises respective first object indication information associated with the Q media items, Q being a positive integer less than or equal to N; and
the acquiring the to-be-decoded media file segment comprises:
determining a target media item from the Q media items according to the respective first object indication information associated with the Q media items, the target media item satisfying a decoding condition; and
determining the to-be-decoded media file segment according to the target media item and first object indication information associated with the target media item.

10. The method according to claim 9, wherein the determining the to-be-decoded media file segment comprises:
determining a point cloud slice from a static media frame corresponding to the target media item according to the first object indication information associated with the target media item, the point cloud slice satisfying the decoding condition; and
determining, from the target media item, code stream data associated with the point cloud slice, the code stream data associated with the point cloud slice being the to-be-decoded media file segment.

11. The method according to claim 1, wherein:
the encapsulated media file comprises a first media file and a second media file;
the object indication information comprises first object indication information of the first media file, second object indication information of the second media file, and object relation indication information;
the object relation indication information indicates that a first media object in a first media frame of the first media file has an association relation with a second media object in a second media frame of the second media file;
the first object indication information of the first media file is encapsulated in the first media file the second object indication information of the second media file is encapsulated in the second media file; and
the acquiring the to-be-decoded media file segment comprises:
acquiring the second media file having an association relation with the first media file according to the object relation indication information when the first media file satisfies a decoding condition; and
determining the to-be-decoded media file segment according to the first media file and the second media file.

12. A method for processing media data, comprising:
acquiring an encapsulated media file that includes N media frames, N being a positive integer;
generating, when the N media frames comprise media objects, object indication information associated with the N media frames, the object indication information indicating respective object property features of the media objects in the N media frames and respective distribution features of the media objects in the N media frames; and
transmitting the encapsulated media file and the object indication information to a decoding device.

13. The method according to claim 12, wherein the transmitting the encapsulated media file and the object indication information to a decoding device comprises:
extracting, when the encapsulated media file comprises S media file segments, respective first object indication information associated with the S media file segments from the object indication information, S being an integer greater than 1;
encapsulating, in a target media file segment i that includes a media file segment i in the S media file segments, first object indication information associated with the media file segment i, S being an integer greater than 1, and i being a positive integer less than or equal to S;
transmitting the respective first object indication information associated with the S media file segments and respective segment identifiers of the S media file segments to the decoding device; and
transmitting, when an acquisition request for the target media file segment i is received, the target media file segment i to the decoding device, the acquisition request being generated by the decoding device based on the respective segment identifiers and the respective first object indication information that are associated with the S media file segments.

14. The method according to claim 12, wherein:
the N media frames comprise K dynamic media frames having media objects;
the encapsulated media file comprises P media tracks that include the K dynamic media frames, P being a positive integer, and K being a positive integer less than or equal to N; and
the transmitting comprises:
acquiring, from the object indication information associated with the N media frames, a first object property feature of a media object in a dynamic media frame of a media track j and a first distribution feature of the media object, j being a positive integer less than or equal to P;
encapsulating the first object property feature of the media object in the dynamic media frame in an object information data box j associated with the media track j;
encapsulating the first object property feature of the media object and the first distribution feature of the media object in a metadata track corresponding to the media track j;
adding respective object information data boxes associated with the P media tracks and respective metadata tracks corresponding to the P media tracks to the encapsulated media file to obtain a target media file; and
transmitting the target media file to the decoding device.

15. The method according to claim 14, wherein:
the metadata track corresponding to the media track j comprises respective metadata track samples corresponding to dynamic media frames in the media track j; and
the encapsulating the first object property feature of the media object and the first distribution feature of the media object comprises:
adding the first object property feature of the media object and the first distribution feature of the media object to a metadata track sample corresponding to the dynamic media frame.

16. The method according to claim 15, wherein:
the encapsulating the first object property feature of the media object and the first distribution feature of the media object comprises:
acquiring a second object property feature of the media object in a reference media frame of the dynamic media frame and a second distribution feature of the media object in the reference media frame of the dynamic media frame;
determining an object change feature between the second object property feature of the media object in the reference media frame and the first object property feature of the dynamic media frame;
determining a distribution change feature between the second distribution feature of the media object in the reference media frame and the first distribution feature of the dynamic media frame; and
adding the object change feature and the distribution change feature to the metadata track sample corresponding to the dynamic media frame.

17. The method according to claim 14, wherein the adding comprises:
adding the object information data box j to a track sample entry of the media track j; and
adding the respective metadata tracks of the P media tracks to the encapsulated media file to obtain the target media file.

18. The method according to claim 14, wherein the adding comprises:
adding the object information data box j to a track sample entry of the metadata track corresponding to the media track j to obtain an added metadata track corresponding to the media track j; and
adding respective added metadata tracks corresponding to the P media tracks to the encapsulated media file to obtain the target media file.

19. The method according to claim 12, wherein:
the N media frames comprise Q static media frames having media objects;
the encapsulated media file comprises Q media items corresponding to the Q static media frames, Q being a positive integer less than or equal to N; and
the transmitting comprises:
acquiring an object property feature of a media object in a static media frame corresponding to a media item r and a distribution feature of the media object in the static media frame, r being a positive integer less than or equal to Q;
encapsulating the object property feature of the media object and the distribution feature of the media object in an item property box associated with the media item r;
adding respective item property boxes associated with the Q media items to the encapsulated media file to obtain a target media file; and
transmitting the target media file to the decoding device.

20. The method according to claim 12, wherein:
the encapsulated media file comprises a first media file and a second media file;
the object indication information comprises object relation indication information;
the object relation indication information indicates that a first media object in a first media frame in the first media file has an association relation with a second media object in a second media frame in the second media file; and
the transmitting comprises:
encapsulating the object relation indication information in an associated entity group box,
encapsulating a first object property feature and a first object distribution feature of the first media object in the first media frame in the first media file,
encapsulating a second object property feature and a second object distribution feature of the second media object in the second media frame in the second media file,
determining a target media file that includes the associated entity group box, the first media file, and the second media file, and
transmitting the target media file to the decoding device.
